(19) United States
(12) Patent Application Publication
(10) Pub. No.: US 2023/0306273 A1
(43) Pub. Date: Sep. 28, 2023

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Kazuya KAKIZAKI, Tokyo (JP); Inderjeet SINGH, Tokyo (JP)

(73) Assignee: NEC Corporation, Minato-ku, Tokyo (JP)

(21) Appl. No.: 18/019,750

(22) PCT Filed: Aug. 20, 2020
(86) PCT No.: PCT/JP2020/031403

§ 371 Date: Feb. 3, 2023

(51) Int. Cl. G06N 3/094

(52) U.S. Cl. CPC G06N 3/094

(57) ABSTRACT

An information processing device includes a guide data acquirer that acquires a plurality of guide data items classified into a single target class; and an adversarial sample generator that generates one adversarial sample by using the plurality of guide data items.

### TECHNICAL FIELD

The present invention relates to an information processing device, an information processing method, and a recording medium.

### BACKGROUND ART

An adversarial example is known as one of the vulnerabilities of models obtained by machine learning. An adversarial sample is a sample that is created such that human perception and the judgment by a model differ, for example by the addition of noise to an image.

In relation to adversarial examples, Patent Document 1 describes a classification device for distinguishing between training data and artificially generated pseudo data. This classification device generates pseudo data, for example, by transforming random data with a pseudo data generation model. Then, this classification device performs learning to update the parameters of the classification model so as to classify training data into real classes and pseudo data into pseudo classes. In addition, this classification device performs learning to update the parameters of the pseudo data generation model so that the difference between the average value of the feature quantity of the training data and the average value of the feature quantity of the pseudo data is reduced.

In addition, Patent Document 1 describes presenting to the user data of new classes that may be derived by classification into pseudo classes. For this purpose, the classification device generates processed pseudo data by transforming learning data or pseudo data by affine transformation, and learns the above classification model so as to classify the processed pseudo data into pseudo classes.

Patent Document 1 discloses an example in which “9” obtained by rotating a handwritten numeral image “6” is generated as pseudo data, and when input data that belongs to class 9 is input, the data is classified into the pseudo class and presented to the user.

Further, Patent Document 2 describes an AX (adversarial sample) generator that can generate adversarial samples with a relatively low likelihood of inducing classification into classes other than the target class. In order to generate such adversarial samples, Patent Document 2 presents an optimization problem that takes into account the similarity between the feature quantity of the adversarial sample candidate data and the feature quantity of the data of the target class, and the similarity between the feature quantity of the adversarial sample candidate data and the feature quantity of data in classes other than the target class. The AX generator solves this optimization problem to generate adversarial samples under the constraint that the magnitude of the difference between the adversarial sample candidate data and the source data is less than or equal to the tolerance.

Further, Patent Document 2 describes, as an example of a method of solving a constrained optimization problem, searching for a solution by converting the constrained optimization problem into a minimization problem of an objective function. As the objective function in this case, an objective function is shown in which the value of the objective function becomes small when the adversarial sample candidate satisfies the constraint, and the value of the objective function becomes small when the evaluation of the adversarial sample candidate in the optimization problem is high.

### CITATION LIST

### Patent Literature

[Patent Document 1] Japanese Unexamined Patent Application, First Publication No. 2020-046883
[Patent Document 2] PCT International Publication No. 2020/121450

### SUMMARY OF INVENTION

### Problems to be Solved by the Invention

If adversarial samples are judged to be similar not only to specific data of the target class but also to multiple data in the determination of the model obtained by machine learning, it is likely that erroneous determination will be induced.

For example, consider a case where a face collation system compares a pre-registered adversarial sample face image with a photographed face image of a person to be collated. In this case, the photographed image can be various images depending on the photographing conditions of the face of the person to be matched. Determining that the face image of the adversarial sample is similar to various face images of the target class may induce erroneous determination that the person to be matched is another person under various photographing conditions.

If adversarial samples that are judged to be similar to multiple data of the target class can be obtained by the judging of a model obtained by machine learning, countermeasures such as construction of a model that is difficult to be deceived by the adversarial samples can be taken.

An example object of the present invention is to provide an information processing device, an information processing method, and a recording medium that can solve the above problem.

### Means for Solving the Problems

According to the first example aspect of the present invention, an information processing device is provided with a guide data acquirer that acquires a plurality of guide data items classified into a single target class; and an adversarial sample generator that generates one adversarial sample by using the plurality of guide data items.

According to the second example aspect of the present invention, the information processing device is provided with an adversarial sample generator that generates an adversarial sample using an objective function containing a term indicating the similarity between a feature quantity of an adversarial sample candidate and feature quantities of guide data items classified into a target class, and a term indicating the norm between the feature quantity of the adversarial sample candidate and the feature quantities of the guide data items.

According to a third example aspect of the present invention, an information processing method includes acquiring a plurality of guide data items classified into a single target class; and generating one adversarial sample by using the plurality of guide data items.

According to a fourth example aspect of the present invention, an information processing method includes generating adversarial samples using an objective function containing a term indicating the similarity between a feature quantity of an adversarial sample candidate and feature quantities of guide data items classified into the target class and a term indicating the norm between the feature quantity of the adversarial sample candidate and the feature quantities of the guide data items.

According to a fifth example aspect of the present invention, a recording medium records a program for causing a computer to execute acquiring a plurality of guide data classified into a single target class, and generating one adversarial sample by using the plurality of guide data items.

According to the sixth example aspect of the present invention, a recording medium records a program for causing a computer to execute generating an adversarial sample using an objective function containing a term indicating the similarity between a feature quantity of an adversarial sample candidate and feature quantities of guide data items classified into a target class, and a term indicating the norm between the feature quantity of the adversarial sample candidate and the feature quantities of the guide data items.

### Advantageous Effects of Invention

According to the information processing device, information processing method, and recording medium described above, an adversarial sample is obtained that can be determined to be similar to a plurality of data items of the target class by the judgement of a model obtained by machine learning.

### BRIEF DESCRIPTION OF DRAWINGS

FIG. 1 is a schematic block diagram showing an example of the functional configuration of the adversarial sample generation device according to the first example embodiment.

FIG. 2 is a flowchart showing an example of the processing procedure in which the adversarial sample generation device according to the first example embodiment generates an adversarial sample.

FIG. 3 is a schematic block diagram showing an example of the functional configuration of the adversarial sample generation device according to the second example embodiment.

FIG. 4 is a flowchart showing an example of the processing procedure in which the adversarial sample generation device according to the second example embodiment generates an adversarial sample.

FIG. 5 is a schematic block diagram showing an example of the functional configuration of the adversarial sample generation device according to the third example embodiment.

FIG. 6 is a flowchart showing an example of the processing procedure in which the adversarial sample generation device according to the third example embodiment generates an adversarial sample.

FIG. 7 is a schematic block diagram showing an example of the functional configuration of the detection model learning device according to the fourth example embodiment.

FIG. 8 is a flowchart showing an example of the processing procedure in which the detection model learning device of the fourth example embodiment performs detection model learning.

FIG. 9 is a schematic block diagram showing an example of the functional configuration of the feature quantity extraction model learning device according to the fifth example embodiment.

FIG. 10 is a flowchart showing an example of the processing procedure in which the feature quantity extraction model learning device according to the fifth example embodiment performs learning of the feature quantity extraction model f.

FIG. 11 is a schematic block diagram showing an example of the functional configuration of the risk evaluation device according to the sixth example embodiment.

FIG. 12 is a flowchart showing an example of the processing procedure in which the risk evaluation device according to the sixth example embodiment calculates similarity.

FIG. 13 is a block diagram showing an example of the configuration of the information processing device according to the seventh example embodiment.

FIG. 14 is a block diagram showing an example of the configuration of the information processing device according to the eighth example embodiment.

FIG. 15 is a diagram showing an example of the processing procedure in the information processing method according to the ninth example embodiment.

FIG. 16 is a diagram showing an example of the processing procedure in the information processing method according to the tenth example embodiment.

FIG. 17 is a schematic block diagram showing the configuration of a computer according to at least one example embodiment.

### EXAMPLE EMBODIMENT

Example Embodiments of the present invention will be described below, but the following example embodiments do not limit the invention according to the claims. Also, not all combinations of features described in the example embodiments are essential for the solution of the invention.

Hereinbelow, the case of face collation will be described as an example. Specifically, assuming the case where a face image of an adversarial sample is pre-registered in a face collation system for the purpose of impersonating another person in face collation, the acquisition of the adversarial sample and countermeasures using the acquired adversarial sample are described.

This face collation system determines whether or not a face image pre-registered for each of a plurality of persons and a face image captured by a camera at the time of matching are face images of the same person. A pre-registered face image is also referred to as a registered image. A face image captured by a camera during face collation is also referred to as a captured image.

For example, this face collation system calculates the similarity between the feature quantity of one registered image and the feature quantity of one captured image. Then, the face collation system determines whether or not the registered image and the captured image are facial images of the same person on the basis of the obtained similarity.

A class is set in advance for each person whose face image is registered in the face collation system, with the face collation system classifying each captured image into a class according to a determination result.

Registering, as a registered image, an adversarial sample having a feature quantity with a high degree of similarity to that of a captured image attracts impersonation of another person.

On the other hand, various captured images are input to the face collation system depending on the intensity of light at the time of imaging, the angle of the face, the facial expression, and the like. This suggests that an adversarial sample having a feature quantity with a high degree of similarity to that of a captured image captured under various shooting conditions is more likely to attract impersonation than an adversarial sample having a feature quantity with a high degree of similarity only to a specific captured image.

However, the application target of the following example embodiments is not limited to face collation. For example, the example embodiments can be applied to various processes that can make use of adversarial samples, such as voice recognition or fingerprint authentication.

### First Example Embodiment

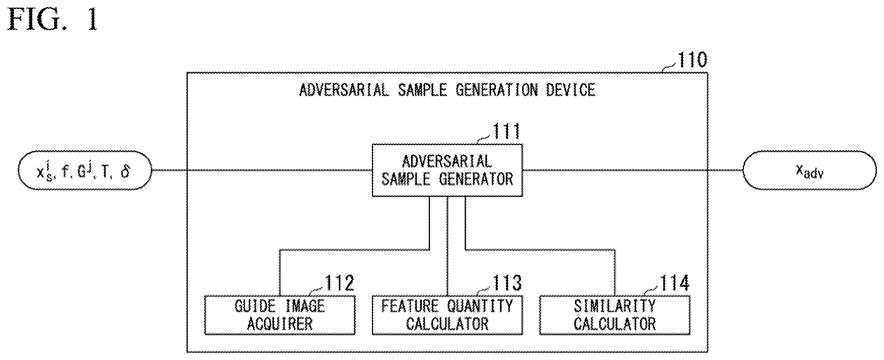

FIG. 1 is a schematic block diagram showing an example of the functional configuration of the adversarial sample generation device according to the first example embodiment. With the configuration shown in FIG. 1, an adversarial sample generation device 110 is provided with an adversarial sample generator 111, a guide image acquirer 112, a feature quantity calculator 113, and a similarity calculator 114.

The adversarial sample generation device 110 acquires a source image xₛⁱ, a feature quantity extraction model f, a guide image set G^{j}, an image transformation function set T, and the maximum perturbation size δ as input data, and outputs an adversarial sample x_{adv}. The adversarial sample generation device 110 may communicate with other devices to receive these input data items from those devices. Alternatively, all or part of these input data items may be acquired in advance, such as by having the adversarial sample generation device 110 store in advance the image transformation function set T and the maximum perturbation size δ.

The adversarial sample generation device 110 corresponds to an example of an information processing device.

The source image xₛⁱ is the facial image from which the adversarial sample x_{adv} is generated. The adversarial samples x_{adv} is generated by adding an adversarial perturbation to the source image xₛⁱ.

Source data are data from which an adversarial sample is generated, and are not limited to images.

The class to which the source image xₛⁱ belongs is denoted as class i. The “i” in “xₛⁱ” indicates class i.

The feature quantity extraction model f receives a face image as an input and outputs the feature quantity of the input face image. The feature quantity output by the feature quantity extraction model f is represented by a vector having real numbers as elements.

A guide image set & is a set of one or more guide images x_{g}^{j}. A guide image x_{g}ⁱ∈Gⁱ is a face image belonging to the target class. The target class is denoted as class j. The “j” in “G” indicates class j. The “j” in “G^{j}” indicates class j.

The guide image x_{g}^{j} is used as a guide to ensure that the adversarial sample x_{adv} is misclassified into class j, which is the class that is the target class. Specifically, the adversarial sample generation device 110 determines the adversarial perturbation such that the feature quantity of the adversarial sample x_{adv} is similar to the feature quantity of the guide image x_{g}^{j}.

Guide data are data used as a guide to ensure that an adversarial sample is misclassified into the target class, and are not limited to images.

The guide image x_{g}^{j} corresponds to an example of guide data. Guide data are data used as a guide to ensure that an adversarial sample is misclassified into the target class, as described above for the guide image x_{g}^{j}. The guide image set G corresponds to an example of a guide data set. A guide data set is a set of one or more guide data items.

The image conversion function set T is a set of one or more image conversion functions t. The image conversion function t∈T is a function that receives an image as an input and outputs a converted image. The elements of the image conversion function set T may include an identity conversion function that outputs an input image as it is.

The maximum perturbation size δ is the maximum size of perturbations (adversarial perturbations) used during adversarial sample generation.

The guide image acquirer 112 acquires a plurality of guide images x_{g}^{j}.

The guide image acquirer 112 may acquire a plurality of real images classified into the target class as a plurality of guide data items. Areal image here is a raw face image acquired by photographing a face subject to face collation, that is, an unprocessed face image. Areal image corresponds to an example of real data. Real data referred to here is raw data acquired from the target to be classified, that is, unprocessed data.

A guide image set G^{j} acquired by the adversarial sample generation device 110 may include a plurality of real images classified into the target class. Then, the guide image acquirer 112 may read out the plurality of real images from the guide image set G^{j} and use them as the plurality of guide images x_{g}^{j}.

However, part or all of the guide images x_{g}^{j} included in the guide image set G^{j} acquired by the adversarial sample generation device 110 may be processed face images. Then, the guide image acquirer 112 may acquire the plurality of guide images x_{g}^{j} by reading the plurality of guide images x_{g}^{j} from the guide image set G^{j}.

The guide image acquirer 112 may generate a new guide image t(x_{g}^{j}) by inputting one or more guide images x_{g}^{j} into the image conversion function t and converting it/them. The generation of the new guide image t(x_{g}^{j}) by the guide image acquirer 112 in this case is also referred to as bulking up the guide images.

A new guide image t(x_{g}^{j}) generated by inputting the guide image x_{g}^{j} into the image conversion function t is also simply referred to as a guide image x_{g}^{j}. The guide image x_{g}^{j} read out from the guide image set G^{j} and the new guide image t(x_{g}^{j}) generated by inputting the guide image x_{g}^{j} into the image transformation function t are generically referred to simply as guide images x_{g}^{j}.

As the image transformation function t, various functions that are expected to transform an image belonging to the target class into an image belonging to the target class can be used.

In particular, as the image conversion function t, a function corresponding to the photographing conditions of the face of the person to be matched may be used.

For example, the image conversion function set T may include a function that changes the brightness of an image (e.g., luminance value) in accordance with the brightness of the lighting at the time of photographing and the degree of light hitting the face of a person to be matched.

The image conversion function set T may include a function for rotating an image (a function for changing the inclination of an image) in accordance with the inclination of the face of a person to be matched.

The image conversion function set T may include a function for enlarging or reducing an image according to the distance between the camera and the face of the person to be matched.

The image transformation function set T may include a function that pseudo-rotates the orientation of the face of the person to be matched, such as enlarging or reducing the image in the horizontal direction according to the orientation of the face of the person to be matched with respect to the camera.

The guide image set G^{j} acquired by the adversarial sample generation device 110 may include one or more guide images x_{g}^{j}. Then, the guide image acquirer 112 may read the guide image x_{g}^{j} from the guide image group G and input the guide image x_{g}^{j} to the image conversion function t to generate a new guide image x_{g}^{j}.

The guide image acquirer 112 newly generates one or more guide images x_{g}^{j}, resulting in a plurality of guide images x_{g}^{j} together with the original guide image x_{g}^{j}. The guide image acquirer 112 may input a newly generated guide image x_{g}^{j} to the image conversion function t to further generate a new guide image x_{g}^{j}.

The guide image acquirer 112 may newly generate a guide image x_{g}^{j} for a combination of all guide images x_{g}^{j} included in the guide image set G and all image transform function sets t included in the image transform function set T. Alternatively, the guide image acquirer 112 may newly generate guide images x_{g}^{j} for only some of these combinations.

The guide image acquirer 112 corresponds to an example of a guide data acquirer.

The adversarial sample generator 111 generates one adversarial sample x_{adv} using a plurality of the guide images x acquired by the guide image acquirer 112. The adversarial sample generator 111 may repeatedly generate adversarial samples x_{adv} to generate a plurality of adversarial samples x_{adv}.

The adversarial sample generator 111 may generate the adversarial sample x_{adv} by solving the optimization problem shown in Equation (1).

$$\begin{matrix}[ Equation 1 ] & \\ {argmax}_{{x}_{adv}} {E}_{{x}_{g}^{j} ∈ {G}^{j}} {E}_{t ∈ T} SIM ( f ( {x}_{adv} ) , f ( t ( {x}_{g}^{j} ) ) ) & ( 1 )\end{matrix}$$

argmax is a function that outputs a value of the argument (“x_{adv}” in Equation (1)) that maximizes the value of the expression to the right thereof (“E_{xgj∈Gj}E_{t∈T}SIM(f(x_{adv}), f(t(x_{g}^{j})))” in Equation (1)).
E represents the expected value.

SIM is a function that calculates similarity. A cosine similarity may be used as SIM, but it is not limited thereto. Various functions can be used as SIM, where the more similar the two vectors shown in the argument are, the larger the value.

“SIM(f(x_{adv}), f(t(x_{g}^{j})))” in Equation (1) indicates the similarity between the feature quantity f(x_{adv}) of the adversarial sample x_{adv} and the feature quantity f(t(x_{g}^{j})) of an image obtained by converting the guide image x_{g}^{j}ᵥ with the image conversion function t. Equation (1) shows an optimization problem of finding the adversarial sample x_{adv} that maximizes the expected value of this similarity for the image transformation function t in the image transformation function set T and the expected value for the guide image x_{g}^{j} in the guide image set G^{j}.

As described above, the number of guide images x_{g}^{j} included in the guide image group G^{j} should be one or more. The number of image transformation functions t included in the image transformation function set T may be one or more, and the image transformation function t may be an identity transformation function that outputs an input image as it is.

As described above, all or part of the plurality of guide images x_{g}^{j} acquired by the guide image acquirer 112 may not use the image transformation function t. In Equation (1), the guide image x_{g}^{j} when the image transformation function t is not used is expressed as “t(x_{g}^{j})”, where t is the identity transformation function. Therefore, “t(x_{g}^{j})” in Equation (1) is the generic term for the guide image “t(xgj)” when the guide image acquirer 112 uses the image transformation function t and the guide image “x_{g}^{j}” when the guide image acquirer 112 does not use the image transformation function t.

On the other hand, a condition is imposed so that the number of guide images x_{g}^{j} handled by the adversarial sample generator 111 in Equation (1) is plural. Specifically, the number of guide images x_{g}^{j} included in the guide image set G^{j} is two or more, or the image conversion function set T includes an image conversion function t other than the identity conversion function, or these both must be established.

Under this condition, the adversarial sample generator 111 obtains adversarial samples x_{adv} such that the feature quantities of the adversarial samples x_{adv} are similar to the feature quantities of any of the plurality of guide images x_{g}^{j}.

A constraint condition may be placed on the magnitude of the adversarial perturbation so that when a person sees the face image of the adversarial sample x_{adv} generated by the adversarial sample generator 111, he or she recognizes that the face image is of the same person as the source image xₛⁱ. For example, the adversarial sample generator 111 may solve the optimization problem shown in Equation (1) above under the constraint condition shown in Equation (2).

[Equation 2]

∥xₛⁱ−x_{adv}∥_{∞}<δ (2)

“∥ ∥_{∞}” indicates the L_{∞} norm. Equation (2) expresses the condition that the L_{∞}. norm of the adversarial perturbation indicated by the difference between the source image xₛⁱ and the adversarial sample x_{adv} is smaller than the maximum perturbation size δ.

The optimization problem represented by the above Equation (1) can be approximately solved by applying the gradient method to the optimization problem of maximizing the value of the objective function J (x_{adv}, f, G^{j}, T) of Equation (3).

$$\begin{matrix}[ Equation 3 ] & \\ J ( {x}_{adv} , f , {G}^{j} , T ) = \frac{1}{\vert {G}^{j} \vert \vert T \vert} {\sum }_{{x}_{g}^{j} ∈ {G}^{j}} {\sum }_{t ∈ T} SIM ( f ( {x}_{adv} ) , f ( t ( {x}_{g}^{j} ) ) ) & ( 3 )\end{matrix}$$

|G^{j}| indicates the number of elements in the guide image set G^{j}. |T| indicates the number of elements of the image conversion function set T.

As in Equation (1), in Equation (3), “t(x_{g}^{j})” is the generic name for the guide image “t(x_{g}^{j})” when the guide image acquirer 112 uses the image transformation function t and the guide image “x_{g}^{j}” when the guide image acquirer 112 does not use the image transformation function t.

Based on the input source image xₛⁱ, the maximum perturbation size δ, and the objective function J (x_{adv}, f, G^{j}, T) calculated by the similarity calculator 114, the adversarial sample generator 111 may update the value of the adversarial sample candidate x_{adv}^{(h)} on the basis of Equation (4).

$$\begin{matrix}[ Equation 4 ] & \\ {x}_{adv}^{( h )} = {x}_{adv}^{( h - 1 )} + l {∇}_{{x}_{adv}} J ( {x}_{adv}^{{( h - 1 )}_{j}} , f , G , T ) & ( 4 )\end{matrix}$$

x_{adv}^{(h)} denotes an adversarial sample candidate updated h times. 1 is a constant coefficient representing the learning rate that determines the update width of the adversarial perturbation.

The suffix of ∇(“x_{adv}” in Equation (4)) indicates that the component indicated by the suffix is differentiated.

The adversarial sample generator 111 updates the adversarial sample candidate x_{adv}^{(h)} so as to maximize the value of the objective function J(x_{adv}, f, G^{j}, T) based on Equation (4).

The adversarial sample generator 111 may change the value of x_{adv}^{(h)} so that the updated adversarial sample candidate x_{adv}^{(h)} satisfies the constraint of Equation (2) above. For example, if the adversarial sample generator 111 calculates the L_{∞} norm of the difference between x_{adv}^{(h)} and xₛⁱ, and the L_{∞} norm is greater than or equal to δ, the adversarial sample generator 111 may change the value of x_{adv}^{(h)} so as to be equal to or less than δ.

The adversarial sample generator 111 performs M₁ times of updating the adversarial sample candidate according to Equation (4). M₁ is an integer satisfying M₁≥1. The value of M₁ may be preset to a fixed value. Alternatively, the user may specify the value of M₁.

The feature quantity calculator 113 calculates the feature quantity of the face image using the feature quantity extraction model f. For example, in the calculation of “J(x_{adv}^{(h-1)}, f, G^{j}, T)” in Equation (4), the feature quantity calculator 113 calculates the feature quantity f (x_{adv}^{(h-1)}) of the adversarial sample candidate x_{adv}^{(h-1)} updated by the adversarial sample generator 111 and the feature quantity f (t(x_{g}^{j})) of each of the guide images t(x_{g}^{j}) obtained by the guide image acquirer 112 using the feature extraction model f. Again, “t(x_{g}^{j})” is a generic term for “t(x_{g}^{j})” and “x_{g}^{j}”.

The similarity calculator 114 calculates the similarity between the feature quantities of the two images based on the feature quantity calculated by the feature quantity calculator 113. For example, the similarity calculator 114 calculates SIM(f(x_{adv}^{(h-1)}), f(t(x_{g}^{j}))) in the calculation of “J(x_{adv}^{(h-1)}, f, G^{j}, T” in Equation (3).

As described above, as the similarity calculation function SIM, it is possible to use a function such as the cosine similarity cos (f(x_{adv}^{(h-1)}), f(t(x_{g}^{j}))) indicating that the higher the value, the higher the similarity between two feature quantities.

Further, the similarity calculator 114 calculates the value of the objective function of the optimization problem based on the calculated similarity. For example, the similarity calculator 114 calculates the value of the objective function J(x_{adv}, f, G^{j}, T) based on Equation (3) in the calculation of Equation (4).

### (Description of Operation)

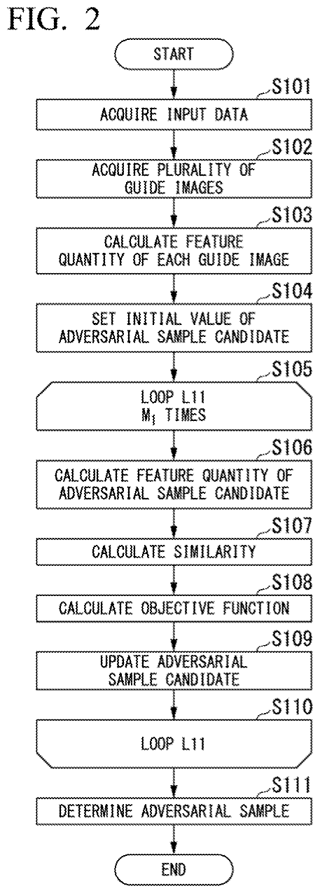

FIG. 2 is a flowchart showing an example of a processing procedure for the adversarial sample generation device 110 to generate adversarial samples.

In the process of FIG. 2, the adversarial sample generator 111 acquires the source image xₛⁱ, the feature quantity extraction model f, the guide image set G, the image transformation function set T, and the maximum perturbation size δ as input data items from outside the adversarial sample generation device 110 (Step S101).

Next, the guide image acquirer 112 acquires a plurality of guide images x_{g}^{j} (Step S102). A plurality of guide images x_{g}^{j} are included in the guide image set G^{j}, and the guide image acquirer 112 may read the plurality of guide images x_{g}^{j} from the guide image set G^{j}. Alternatively, the guide image acquirer 112 may bulk up the guide images x_{g}^{j}. Alternatively, the guide image acquirer 112 may perform both reading out of the plurality of guide images x_{g}^{j} from the guide image group G^{j} and bulking up of the guide images x_{g}^{j}.

Next, the feature quantity calculator 113 inputs each of the plurality of guide images t(x_{g}^{j}) to the feature extraction model f, and calculates the feature quantity of each of the guide images x_{g}^{j} (Step S103).

Next, the adversarial sample generator 111 sets the initial value x_{adv}⁽⁰⁾ of an adversarial sample candidate (Step S104). For example, the adversarial sample generator 111 may assign a value of the source image xₛⁱ (image data) to the initial value x_{adv}⁽⁰⁾ of an adversarial sample candidate.

Next, the adversarial sample generation device 110 starts loop L11 (Step S105).

In the process of loop L11, the feature quantity calculator 113 calculates the feature quantity of the adversarial sample candidate x_{adv}^{(h-1)} (Step S106).

Next, the similarity calculator 114 calculates the similarity between the feature quantity f(x_{adv}^{(h-1)}) of the adversarial sample candidate x_{adv}^{(h-1)} and each of the feature quantities of the plurality of guide images x_{g}^{j} acquired by the guide image acquirer 112 (Step S107).

Next, the similarity calculator 114 calculates the value of the objective function J(x_{adv}, f, G^{j}, T) based on the similarity calculated in Step S107 (Step S108).

Next, the adversarial sample generator 111 updates the value of the adversarial sample candidate x_{adv}^{(h)} on the basis of Equation (4) (Step S109).

Next, the adversarial sample generation device 110 performs termination of the loop L11 (Step S110). Specifically, the adversarial sample generation device 110 determines whether or not the process of loop L11 has been repeated M₁ times. If it is determined that the process of loop L11 has not been repeated M₁ times, the adversarial sample generation device 110 continues to repeat the process of loop L11.

On the other hand, if it is determined that the process of loop L11 has been repeated M₁ times, the adversarial sample generation device 110 terminates the loop L11.

When the adversarial sample generation device 110 terminates the loop L11 in Step S110, the adversarial sample generator 111 determines the value of the adversarial sample x_{adv} (Step S111). Specifically, the adversarial sample generator 111 adopts the value of the adversarial sample candidate x_{adv}^{(M1)}, that is, the latest value of the adversarial sample candidate, as the value of the adversarial sample x_{adv}.

After Step S111, the adversarial sample generation device 110 ends the processing of FIG. 2.

As described above, the guide image acquirer 112 acquires a plurality of guide images x_{g}^{j} classified into a single target class. The adversarial sample generator 11I generates one adversarial sample x_{adv} using a plurality of guide images x_{g}^{j}.

Thereby, the adversarial sample generator 111 can generate an adversarial sample x_{adv} having a feature quantity similar to each of the feature quantities of the plurality of guide images x_{g}^{j}. In this respect, the adversarial sample generator 11I can generate an adversarial sample x_{adv} with high feature quantity similarity to the various captured images captured during matching.

In this way, according to the adversarial sample generation device 110, an adversarial sample x_{adv} is obtained that can be determined to be similar to a plurality of data items of the target class by the determination of a model obtained by machine learning.

For example, by using this adversarial sample x_{adv} as training data, it is possible to take measures such as learning a model that is less likely to be deceived by this adversarial sample x_{adv}.

The optimization problem shown in Equations (1) and (2) above, or alternatively the optimization problem shown in Equations (2) through (4) can be viewed as an adversarial sample x_{adv} learning model using the guide images x_{g}^{j} as training data. By using the plurality of guide images x_{g}^{j}, the adversarial sample generation device 110 can prevent over-learning with respect to a specific guide image x_{g}^{j}.

Also, the guide image acquirer 112 acquires a plurality of real images classified into the target class as a plurality of guide images. Specifically, the guide image set G^{j} input from the outside of the adversarial sample generation device 110 includes a plurality of real images of the person to be matched. Then, the guide image acquirer 112 reads out the plurality of real images from the guide image set G^{j}.

As a result, the guide image acquirer 112 can acquire a plurality of guide images without performing processing such as image conversion. In this respect, the load on the guide image acquirer 112 is small.

Also, the guide image acquirer 112 converts one or more guide images to generate a new guide image.

Thereby, the guide image acquirer 112 can obtain more guide images than the number of guide images included in the guide image set G^{j}. In particular, even when the number of guide images included in the guide image set G^{j} is only one, the guide image acquirer 112 can acquire a plurality of guide images.

### Second Example Embodiment

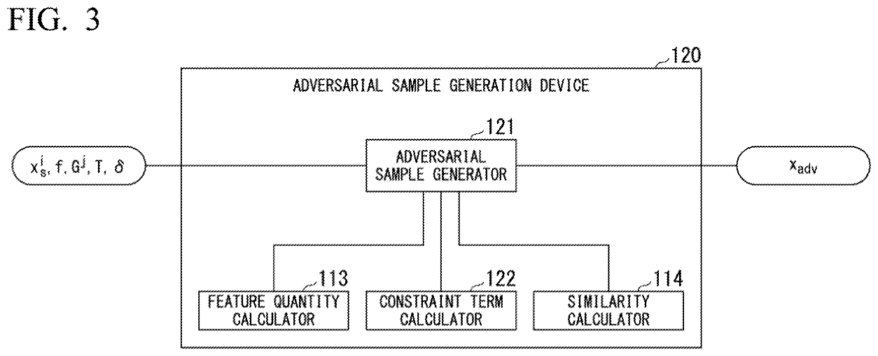

FIG. 3 is a schematic block diagram showing an example of the functional configuration of the adversarial sample generation device according to the second example embodiment. With the configuration shown in FIG. 3, the adversarial sample generation device 120 is provided with an adversarial sample generator 12, a feature quantity calculator 113, a constraint term calculator 122, and a similarity calculator 114.

In the configuration of FIG. 3, those portions having similar functions corresponding to the respective portions of FIG. 1 are given the same reference numerals (113, 114), and detailed description thereof will be omitted here.

The adversarial sample generation device 120 according to the second example embodiment differs the adversarial sample generation device 110 according to the first example embodiment on the point of being provided with the constraint term calculator 122 instead of the guide image acquirer 112 of FIG. 1.

While the adversarial sample generation device 110 obtains multiple guide images x_{g}^{j}, the adversarial sample generation device 120 obtains one guide image x_{g}^{j}. Also, the adversarial sample generation device 120 does not bulk up the guide image x_{g}^{j}. Therefore, the adversarial sample generation device 120 is not provided with the guide image acquirer 112.

In the adversarial sample generation device 120, the processing performed by the adversarial sample generator 121 is different from that of the adversarial sample generator 111 of the adversarial sample generation device 110.

In other respects, the adversarial sample generation device 120 is similar to the adversarial sample generation device 110.

As described above, the adversarial sample generation device 110 uses multiple guide images x_{g}^{j} to prevent over-learning for a specific guide image x_{g}^{j}. On the other hand, in the adversarial sample generation device 120, the objective function for generating an adversarial sample x_{adv} is provided with a constraint term for preventing over-learning with respect to a specific guide image x_{g}^{j}.

The adversarial sample generation device 120 acquires the source image xₛⁱ, the feature extraction model f, the guide image x_{g}^{j}, and the maximum perturbation size δ as input data, and outputs the adversarial sample x_{adv}. The adversarial sample generation device 120 may communicate with other devices to receive these input data items from those devices. Alternatively, all or part of these input data items may be acquired in advance, such as by having the adversarial sample generation device 120 store in advance the maximum perturbation size δ.

Comparing the input data to the adversarial sample generation device 120 with the input data to the adversarial sample generation device 110, the adversarial sample generation device 110 acquires multiple guide images x_{g}^{j}, whereas the adversarial sample generation device 120 acquires one guide image x_{g}^{j}. Also, while the adversarial sample generation device 110 acquires the image transformation function set T, the adversarial sample generation device 120 does not acquire the image transformation function set T.

The input data to the adversarial sample generation device 120 is otherwise similar to the input data to the adversarial sample generation device 110.

The adversarial sample generation device 120 corresponds to an example of an information processing device.

The adversarial sample generator 121 may generate the adversarial sample x_{adv} by solving the optimization problem shown in Equation (5).

$$\begin{matrix}[ Equation 5 ] & \\ {argmax}_{{x}_{adv}} SIM ( f ( {x}_{adv} ) , f ( {x}_{g}^{j} ) + c {‖ f ( {x}_{adv} ) - f ( {x}_{g}^{j} ) ‖}_{p} & ( 5 )\end{matrix}$$

The term “SIM(f(x_{adv}), f(x_{g}^{j}))” in Equation (5) is identical to “SIM(f (x_{adv}), f(t(x_{g}^{j})))” in Equation (1), except that there is no application of the image transformation function t to the guide image x_{g}^{j}.

The term “c∥f(x_{adv})−f(x_{g}^{j})∥ₚ” in Equation (5) is a constraint term for preventing over-learning for a specific guide image x_{g}^{j}.

“c” of this constraint term is a parameter for adjusting the degree of influence of the constraint term on the term “SIM(f(x_{adv}), f(x_{g}^{j}))”, where c>0. The value of parameter c may be set to a fixed value in advance. Alternatively, the user may specify the value of parameter c.

“∥ ∥ₚ” indicates the Lₚ norm. p takes a value of 1, 2, or ∞. The value of p may be preset to a fixed value. Alternatively, the user may specify the value of p.

Further, an operation other than the Lₚ norm may be used, such as using the Huber loss for this constraint term.

A constraint condition may be placed on the magnitude of the adversarial perturbation so that when a person sees the face image of the adversarial sample x_{adv} generated by the adversarial sample generator 121, he or she recognizes that the face image is of the same person as the source image xₛⁱ. As a constraint condition in this case, the constraint condition shown in the above Equation (2) can be used. For example, the adversarial sample generator 121 may solve the optimization problem shown in Equation (5) above under the constraint condition shown in Equation (2).

The optimization problem represented by the above Equation (5) can be approximately solved by applying the gradient method to the optimization problem of maximizing the value of the objective function J (x_{adv}, f, x_{g}^{j}) of Equation (6).

[Equation 6]

J(x_{adv},f,x_{g}^{j})=SIM (f(x_{adv}),f(x_{g}^{j}))+C∥f(x_{adv})−f(x_{g}^{j})∥p (6)

Based on the input source image xₛⁱ, the maximum perturbation size δ, and the objective function J (x_{adv}, f, x_{g}ⁱ) calculated by the similarity calculator 114, the adversarial sample generator 121 may update the adversarial sample candidate x_{adv}^{(h)} on the basis of Equation (7).

[Equation 7]

x_{adv}(h)=x_{adv}^{(h-1)}+l∇_{X}_{_{adv}}J(x_{adv}^{(h-1)},f,x_{g}^{j}) (7)

Equation (7) is the same as Equation (4) except that the objective function is “J(x_{adv}, f, x_{g}^{j})” according to Equation (6).

The adversarial sample generator 121 updates the adversarial sample candidate x_{adv}^{(h)} so as to maximize the objective function J(x_{adv}, f, x_{g}^{j}) based on Equation (7).

The adversarial sample generator 121 may change the value of x_{adv}^{(h)} so that the updated adversarial sample candidate x_{adv}^{(h)} satisfies the constraint of Equation (2) above. For example, if the adversarial sample generator 121 calculates the L_{∞} norm of the difference between x_{adv}^{(h)} and xₛⁱ, and the L_{∞} norm is greater than or equal to δ, the adversarial sample generator 111 may change the value of x_{adv}^{(h)} so as to be equal to or less than δ.

The adversarial sample generator 121 performs M₂ times of updating the adversarial sample candidate according to Equation (6). M₂ is an integer satisfying M₂≥1. The value of M₂ may be set to a fixed value in advance. Alternatively, the user may specify the value of M₂.

The feature quantity calculator 113 calculates the feature quantity of the face image using the feature quantity extraction model f, as in the first example embodiment.

In the second example embodiment, the adversarial sample generation device 120 acquires one guide image x_{g}^{j}. Along with this, the feature quantity calculator 113, for example, in the calculation of “J(x_{adv}^{(h-1)}, f, x_{g}^{j})” in Equation (7), uses the feature quantity extraction model f to calculate the feature quantity f(x_{adv}^{(h-1)}) of the adversarial sample candidate x_{adv}⁽¹⁾ updated by the adversarial sample generator 121, and the feature quantity f(x_{g}^{j}) of the guide image x_{g}^{j}.

The constraint term calculator 122 uses the feature quantity calculated by the feature quantity calculator 113 to calculate the constraint term “c∥f(x_{adv})−f(x_{g}^{j})∥ₚ”.

Similar to the first example embodiment, the similarity calculator 114 calculates the similarity between the feature quantities of the two images based on the feature quantity calculated by the feature quantity calculator 113. Further, the similarity calculator 114 calculates the value of the objective function of the optimization problem based on the calculated similarity, as in the first example embodiment.

For example, the similarity calculator 114 calculates the value of the objective function J(x_{adv}, f, x_{g}^{j}) based on Equation (6) in the calculation of Equation (7).

(Description of operation)

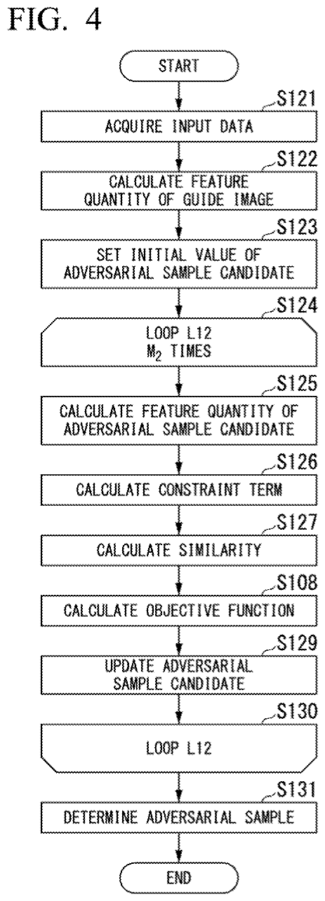

FIG. 4 is a flowchart showing an example of a processing procedure for the adversarial sample generation device 120 to generate adversarial samples.

In the process of FIG. 4, the adversarial sample generator 121 acquires the source image xₛⁱ, the feature quantity extraction model f, the guide image x_{g}^{j}, and the maximum perturbation size δ as input data from outside the adversarial sample generation device 120 (Step S121).

Next, the feature quantity calculator 113 inputs the guide image x_{g}^{j} to the feature extraction model f to calculate the feature quantity of the guide image x_{g}^{j} (Step S122).

Next, the adversarial sample generator 121 sets the initial value x_{adv}⁽⁰⁾ of the adversarial sample candidate (Step S123). For example, the adversarial sample generator 121 may assign a value of the source image xₛⁱ (image data) to the initial value x_{adv}⁽⁰⁾ of the adversarial sample candidate.

Next, the adversarial sample generation device 120 starts loop L12 (Step S124).

In the process of loop L12, the feature quantity calculator 113 calculates the feature quantity of the adversarial sample candidate x_{adv}^{(h-1)} (Step S125).

Next, the constraint term calculator 122 calculates the value of the constraint term “c∥f(x_{adv})−f(x_{g}^{j})∥ₚ” in Equation (6) (Step S126).

Next, the similarity calculator 114 calculates the similarity between the feature quantity f(x_{adv}^{(h-1)}) of the adversarial sample candidate x_{adv}^{(h-1)} and the feature quantity f(x_{g}^{j}) of the guide image x_{g}^{j} (Step S127).

Next, the similarity calculator 114 calculates the value of the objective function J (x_{adv}, f, x_{g}^{j}) based on the similarity calculated in Step S127 and the value of the constraint term calculated by the constraint term calculator 122 in Step S126 (Step S128).

Next, the adversarial sample generator 121 updates the value of the adversarial sample candidate x_{adv}^{(h)} on the basis of Equation (7) (Step S129).

Next, the adversarial sample generation device 120 performs termination of the loop L12 (Step S130). Specifically, the adversarial sample generation device 120 determines whether or not the process of loop L12 has been repeated M₂ times. If it is determined that the process of loop L12 has not been repeated M₂ times, the adversarial sample generation device 120 continues to repeat the process of loop L12.

On the other hand, if it is determined that the process of loop L12 has been repeated M₂ times, the adversarial sample generation device 120 terminates the loop L12.

When the adversarial sample generation device 120 terminates the loop L12 in Step S120, the adversarial sample generator 121 determines the value of the adversarial sample x_{adv} (Step S131). Specifically, the adversarial sample generator 121 adopts the value of the adversarial sample candidate x_{adv}^{(M2)}, that is, the latest value of the adversarial sample candidate, as the value of the adversarial sample x_{adv}.

After Step S131, the adversarial sample generation device 120 ends the processing of FIG. 4.

As described above, the adversarial sample generator 121 generates an adversarial sample using an objective function containing a term indicating the similarity between the feature quantity of the adversarial sample candidate x_{adv}(h−¹) and the feature quantity of the guide image x_{g}^{j}, and a term indicating the norm of the feature quantity of the adversarial sample candidate x_{adv}^{(h-1)} and the feature quantity of the guide image x_{g}^{j}.

The adversarial sample generator 121 can generate the adversarial sample x_{adv} having a feature quantity similar to the feature quantity of not only one specific guide image x but also each of a plurality of guide images x by this constraint term. In this respect, the adversarial sample generator 121 can generate an adversarial sample x_{adv} with high feature quantity similarity to the various captured images captured during matching.

In this way, according to the adversarial sample generation device 120, an adversarial sample x_{adv} is obtained that can be determined to be similar to a plurality of data items of the target class by the determination of a model obtained by machine learning.

For example, by using this adversarial sample x_{adv} as training data, it is possible to take measures such as learning a model that is less likely to be deceived by this adversarial sample x_{adv}.

The optimization problem shown in Equations (2) and (5) above, or alternatively the optimization problem shown in Equations (2), (6) and (7) can be viewed as an adversarial sample x_{adv} learning model using the guide images x_{g}^{j} as training data. In the adversarial sample generation device 120, by providing a constraint term in the objective function of the optimization problem, it is possible to prevent over-learning for a specific guide image x_{g}^{j}.

### Third Example Embodiment

In the third example embodiment, a case where the first example embodiment and the second example embodiment are combined will be described.

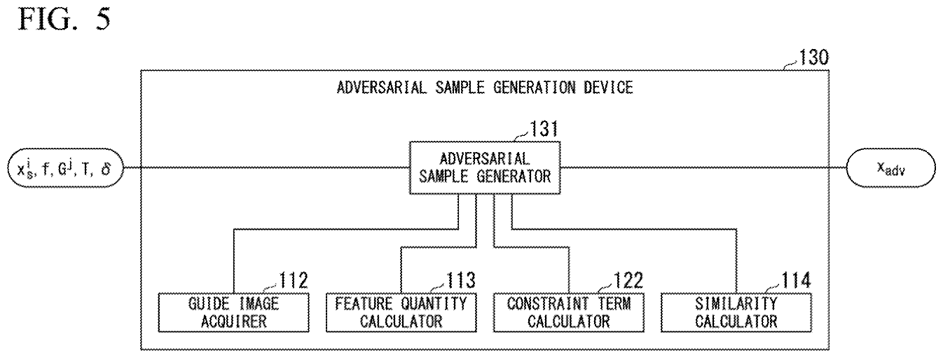

FIG. 5 is a schematic block diagram showing an example of the functional configuration of the adversarial sample generation device according to the third example embodiment. With the configuration shown in FIG. 5, an adversarial sample generation device 130 is provided with an adversarial sample generator 131, a guide image acquirer 112, a feature quantity calculator 113, a constraint term calculator 122, and a similarity calculator 114.

The adversarial sample generation device 130 according to the third example embodiment is provided with the constraint term calculator 122 in addition to each part of the adversarial sample generation device 110 (see FIG. 1) according to the first example embodiment. Accordingly, the operation of the adversarial sample generator 131 of the adversarial sample generation device 120 differs from that of the adversarial sample generator 111 of the adversarial sample generation device 110.

In other respects, the adversarial sample generation device 130 is similar to the adversarial sample generation device 110.

The adversarial sample generation device 130 corresponds to an example of an information processing device.

The guide image acquirer 112, the feature quantity calculator 113, and the similarity calculator 114 of the adversarial sample generation device 130 are the same as those described in the first example embodiment, and so detailed descriptions thereof are omitted here.

The constraint term calculator 122 of the adversarial sample generation device 130 is the same as described in the second example embodiment, and so a detailed description is omitted here.

The adversarial sample generator 131 performs the same processing as the processing performed by the adversarial sample generator 111 in the first example embodiment. Furthermore, the adversarial sample generator 131 generates an adversarial sample x_{adv} using an objective function including a constraint term, similarly to the adversarial sample generator 121 in the second example embodiment.

The adversarial sample generator 131 may generate the adversarial sample x_{adv} by solving the optimization problem represented by Equation (8) instead of Equation (1) above.

$$\begin{matrix}[ Equation 8 ] & \\ {argmax}_{{x}_{adv}} {E}_{{x}_{g}^{j} ∈ {G}^{j}} {E}_{t ∈ T} SIM ( f ( {x}_{adv} ) , f ( t ( {x}_{g}^{j} ) ) ) + c {‖ f ( {x}_{adv} ) - f ( r ( {x}_{g}^{j} ) ) ‖}_{p} & ( 8 )\end{matrix}$$

In Equation (8), the constraint term “c∥f(x_{adv})−f(t(x_{g}^{j}))∥ₚ” is provided in addition to Equation (1). In the constraint term “c∥f(x_{adv})−f(t(x_{g}^{j}))∥ₚ”, “f(t(x_{g}^{j})” replaces “f(x_{g}^{j})” of the constraint term “c∥f(x_{adv})−f(x_{g}^{j})∥ₚ” in Equation (5).

In the third example embodiment, as in the first example embodiment, the fact that the guide image acquirer 112 can apply the image transformation function t to the guide image x_{g}^{j} is reflected in the constraint term.

In Equation (8), “t(x_{g}^{j})” is the generic name for the guide image “t(x_{g}^{j})” when the guide image acquirer 112 uses the image transformation function t and the guide image “x_{g}^{j}” when the guide image acquirer 112 does not use the image transformation function t.

A constraint condition may be placed on the magnitude of the adversarial perturbation so that when a person sees the face image of the adversarial sample x_{adv} generated by the adversarial sample generator 131, he or she recognizes that the face image is of the same person as the source image xₛⁱ. As a constraint condition in this case, the constraint condition shown in the above Equation (2) can be used. For example, the adversarial sample generator 131 may solve the optimization problem shown in Equation (8) above under the constraint condition shown in Equation (2).

The optimization problem represented by the above Equation (8) can be approximately solved by applying the gradient method to the optimization problem of maximizing the value of the objective function J (x_{adv}, f, G^{j}, T) of Equation (9).

$$\begin{matrix}[ Equation 9 ] & \\ J ( {x}_{adv} , f , {G}^{j} , T ) = \frac{1}{\vert {G}^{j} \vert \vert T \vert} {\sum }_{{x}_{g}^{j} ∈ {G}^{j}} {\sum }_{t ∈ T} ( SIM ( f ( {x}_{adv} ) , f ( t ( {x}_{g}^{j} ) ) ) + c {‖ f ( {x}_{adv} ) - f ( t ( {x}_{g}^{j} ) ) ‖}_{p} ) & ( 9 )\end{matrix}$$

In Equation (9), the constraint term “c∥f(x_{adv})−f(t(x_{g}^{j}))∥ₚ” similar to that in Equation (8) is provided in addition to Equation (3).

In Equation (9), “t(x_{g}^{j})” is the generic name for the guide image “t(x_{g}^{j})” when the guide image acquirer 112 uses the image transformation function t and the guide image “x_{g}^{j}” when the guide image acquirer 112 does not use the image transformation function t.

Based on the input source image xₛⁱ, the maximum perturbation size δ, and the objective function J (x_{adv}, f, G^{j}, T) calculated by the similarity calculator 114, the adversarial sample generator 131 may update the value of the adversarial sample candidate x_{adv}^{(h)} on the basis of the above Equation (4).

The adversarial sample generator 131 updates the adversarial sample candidate x_{adv}^{(h)} so as to maximize the value of the objective function J(x_{adv}, f, G^{j}, T) based on Equation (4).

In the third example embodiment, the similarity calculator 114 uses Equation (9) instead of Equation (3) to calculate the value of the objective function “J((x_{adv}, f, G^{j}, T)” of Equation (4).

The adversarial sample generator 131 may change the value of x_{adv}^{(h)} so that the updated adversarial sample candidate x_{adv}^{(h)} satisfies the constraint of Equation (2) above. For example, if the adversarial sample generator 131 calculates the L_{∞} norm of the difference between x_{adv}^{(h)} and xₛⁱ, and the L_{∞} norm is greater than or equal to a, the adversarial sample generator 111 may change the value of x_{adv}^{(h)} so as to be equal to or less than δ.

The adversarial sample generator 131 performs M₃ times of updating the adversarial sample candidate according to Equation (4). M₃ is an integer satisfying M₃≥1. The value of M₃ may be set to a fixed value in advance. Alternatively, the user may specify the value of M₃.

### (Description of Operation)

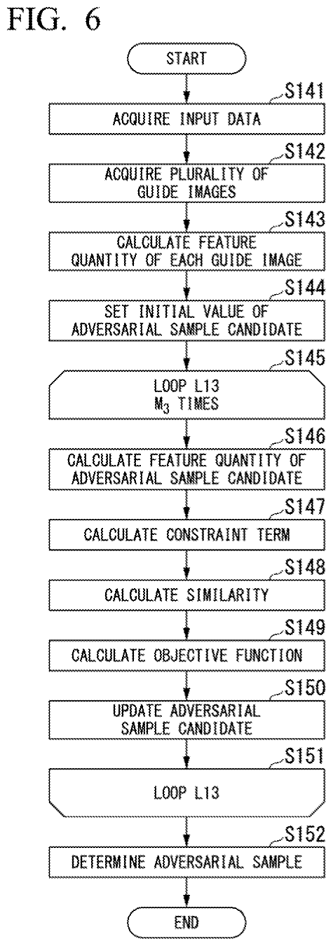

FIG. 6 is a flowchart showing an example of a processing procedure for the adversarial sample generation device 130 to generate an adversarial sample.

Steps S141 to S146 are the same as steps S101 to S106 in FIG. 2.

In FIG. 6, the adversarial sample generation device 110 in the case of FIG. 2 is replaced by adversarial sample generation device 130, and the adversarial sample generator 111 is replaced by the adversarial sample generator 131.

After Step S146, the constraint term calculator 122 calculates the value of the constraint term “c∥f(x_{adv})−f(t(x_{g}^{j}))∥ₚ” of Equation (9) (Step S147).

Step S148 is the same as Step S107 in FIG. 2.

Next, the similarity calculator 114 calculates the value of the objective function J (x_{adv}, f, G^{j}, T) based on the similarity calculated in Step S148 and the value of the constraint term calculated by the constraint term calculator 122 in Step S146 (Step S149).

Next, the adversarial sample generator 131 updates the value of the adversarial sample candidate x_{adv}^{(h)} on the basis of Equation (4) (Step S150).

Next, the adversarial sample generation device 130 performs termination of the loop L13 (Step S151). Specifically, the adversarial sample generation device 130 determines whether or not the process of loop L13 has been repeated M₃ times. If it is determined that the process of loop L13 has not been repeated M₃ times, the adversarial sample generation device 130 continues to repeat the process of loop L13.

On the other hand, if it is determined that the process of loop L13 has been repeated M₃ times, the adversarial sample generation device 130 terminates the loop L13.

When the adversarial sample generation device 130 terminates the loop L13 in Step S151, the adversarial sample generator 131 determines the value of the adversarial sample x_{adv} (Step S152). Specifically, the adversarial sample generator 131 adopts the value of the adversarial sample candidate x_{adv}^{(M3)}, that is, the latest value of the adversarial sample candidate, as the value of the adversarial sample x_{adv}.

After Step S152, the adversarial sample generation device 130 ends the processing of FIG. 6.

As described above, the guide image acquirer 112 acquires a plurality of guide images x_{g}^{j} classified into a single target class. The adversarial sample generator 131 generates one adversarial sample using a plurality of guide images x and using an objective function containing a term indicating the similarity between the feature quantity of the adversarial sample candidate x_{adv}^{(h-1)} and the feature quantity of the guide image x_{g}^{j}, and a term indicating the norm of the feature quantity of the adversarial sample candidate x_{adv}^{(h-1)} and the feature quantity of the guide image x_{g}^{j}.

Thereby, the adversarial sample generator 131 can generate an adversarial sample x_{adv} having a feature quantity similar to each of the feature quantities of the plurality of guide images x_{g}^{j}. In this respect, the adversarial sample generator 131 can generate an adversarial sample x_{adv} with high feature quantity similarity to the various captured images captured during matching.

The adversarial sample generator 131 can generate the adversarial sample x_{adv} having a feature quantity similar to the feature quantity of not only one specific guide image x but also each of a plurality of guide images x by the constraint term of the objective function. The adversarial sample generator 131 in this respect can generate an adversarial sample x_{adv} with high feature quantity similarity to the various captured images captured during matching.

In this way, according to the adversarial sample generation device 130, an adversarial sample x_{adv} is obtained that can be determined to be similar to a plurality of data items of the target class by the determination of a model obtained by machine learning.

For example, by using this adversarial sample x_{adv} as training data, it is possible to take measures such as learning a model that is less likely to be deceived by this adversarial sample x_{adv}.

The optimization problem shown in Equations (2) and (8) above, or alternatively the optimization problem shown in Equations (2), (4) and (9) can be viewed as an adversarial sample x_{adv} learning model using the guide images x_{g} as training data. The adversarial sample generation device 130 can prevent over-learning for a specific guide image x_{g}^{j} by using a plurality of guide images x_{g}^{j} and providing a constraint term in the objective function of the optimization problem.

### Fourth Example Embodiment

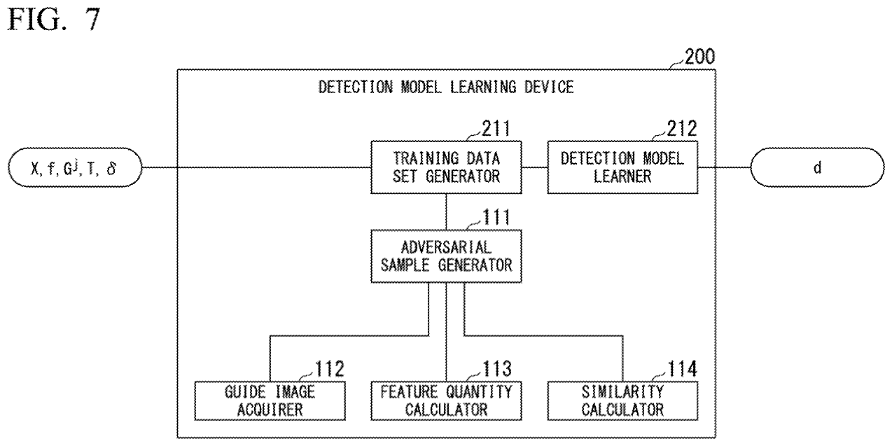

FIG. 7 is a schematic block diagram showing an example of the functional configuration of the detection model learning device according to the fourth example embodiment. With the configuration shown in FIG. 7, a detection model learning device 200 is provided with an adversarial sample generator 111, a guide image acquirer 112, a feature quantity calculator 113, a similarity calculator 114, a training data set generator 211, and a detection model learner 212.

In the configuration of FIG. 7, those portions having similar functions corresponding to the respective portions of FIG. 1 are given the same reference numerals (111, 112, 113, 114), and detailed description thereof will be omitted here.

The detection model learning device 200 is further provided with a training data set generator 211 and a detection model learner 212 in addition to the units included in the adversarial sample generation device 110 of FIG. 1.

The detection model learning device 200 uses the adversarial sample generated by the adversarial sample generator 111 as training data to learn a model for detecting adversarial samples. A model for detecting adversarial samples is also called a detection model.

A detection model classifies the input data into either an adversarial sample class or a normal data class. Here, normal data means data other than adversarial samples.

With this classification, the detection model distinguishes between adversarial samples and normal data. That is, the detection model predicts whether the incoming data are adversarial samples or normal data.

In the fourth example embodiment, a case of learning a detection model using an adversarial sample obtained in the first example embodiment will be described.

However, instead of the first example embodiment, the adversarial sample obtained in the second example embodiment may be used to learn the detection model. Alternatively, detection model learning may be performed using an adversarial sample obtained in the third example embodiment, which corresponds to a combination of the first example embodiment and the second example embodiment.

When learning a detection model using the adversarial sample obtained in the second example embodiment, the detection model learning device 200 may be provided with the adversarial sample generator 121 and the constraint term calculator 122 of FIG. 3 in place of the adversarial sample generator 111 and the guide image acquirer 112 in FIG. 1.

When learning a detection model using the adversarial sample obtained in the third example embodiment, the detection model learning device 200 may further include the constraint term calculator 122 in addition to the units shown in FIG. 7.

The detection model learning device 200 acquires the data set X, the feature quantity extraction model f, the image transformation function set T, and the maximum perturbation size δ as input data, and outputs the detection model d. For example, the detection model learning device 200 may output the parameter values of the detection model d obtained by learning the detection model d.

A data set X is a set whose elements are the pair (xₛⁱ, G^{j}) of a source image xₛ^{j} and a guide image set G^{j}.

As described above, the feature quantity extraction model f receives a face image as an input and outputs a multidimensional vector having real numbers as elements.

As described above, the image transformation function set T is a set of one or more image processing functions t.

The sensing model training device 200 may communicate with other devices to receive these input data items from those devices. Alternatively, the detection model learning device 200 may acquire all or part of these input data items in advance, such as by storing in advance the image transformation function set T and the maximum perturbation size δ.

The detection model learning device 200 corresponds to an example of an information processing device.

The training data set generator 211 generates a training data set Xₜᵣ for learning the detection model d. For this purpose, the training data set generator 211 first outputs the pair (xₛⁱ, G^{j})∈X of all source images xₛⁱ in the data set X and the guide image set G^{j}, the feature extraction model f, the image transformation function set T, and the maximum perturbation size δ to the adversarial sample generator 111.

The adversarial sample generator 111 uses the data from the training data set generator 211 to generate an adversarial sample x_{adv} for each pair (xₛⁱ, G^{j}) with the guide image set G^{j}. As a result, the training data set generator 211 generates |X| adversarial samples x_{adv}. |X| represents the number of elements in the set X.

Then, the training data set generator 211 attaches different labels depending on the xₛⁱ in the data set X and the adversarial sample generated by the adversarial sample generator 111 to construct the training data set Xₜᵣ. The number of elements in the training data set Xₜᵣ is |Xₜᵣ|=2|X|.

The detection model learner 212 learns the detection model d using the training data set Xₜᵣ generated by the training data set generator 211.

For example, the detection model d may be configured using a neural network that performs binary classification. In this case, the neural network can be trained, for example, using a cross-entropy loss function.

The detection model learner 212 may randomly select B elements from the training data set Xₜᵣ to generate a mini-batch. B is an integer such that B≥1. The value of B may be preset to a fixed value. Alternatively, the user may specify the value of B.

Then, the detection model learner 212 may update the parameters of the neural network by applying the gradient method to the loss function calculated using the mini-batch.

The detection model learner 212 may repeat the generation of the mini-batch and the learning of the detection model d M₄ times. M₄ is an integer satisfying M₄≥1. The value of M₄ may be set to a fixed value in advance. Alternatively, the user may specify the value of M₄.

However, the learning algorithm for detection model d is not limited to a specific one. As a learning algorithm for the detection model d, various algorithms capable of learning a neural network for binary classification can be used.

### (Description of Operation)

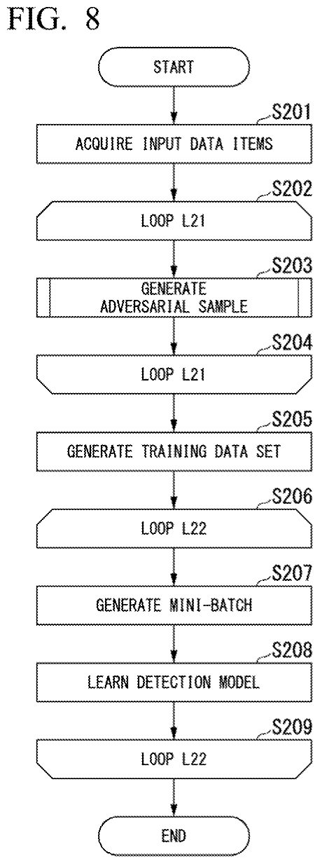

FIG. 8 is a flowchart showing an example of a processing procedure in which the detection model learning device 200 performs detection model learning.

In the process of FIG. 8, the training data set generator 211 acquires the data set X, the feature extraction model f, the image transformation function set T, and the maximum perturbation size δ from outside the detection model learning device 200 as input data items (Step S201).

Next, the detection model learning device 200 starts loop L21 (step S202).

In the process of loop L21, the detection model learning device 200 generates an adversarial sample x_{adv} for each data (xₛⁱ, G^{j}) included in the data set X (Step S203). In Step S203, the detection model learning device 200 performs the process of Step S102 and subsequent steps in FIG. 2 to generate an adversarial sample x_{adv}.

Next, the detection model learning device 200 terminates the loop L21 (Step S204). Specifically, the detection model learning device 200 makes a determination whether an adversarial sample was generated in Step S203 for all the data (xₛⁱ, G^{j}) included in the data set X. If it is determined that there are data items (xₛⁱ, G^{j}) that have not been processed in Step S203, the detection model learning device 200 continues to perform the process of Step S203 on the data (xₛⁱ, G^{j}) that has not been processed in Step S203.

On the other hand, when it is determined that adversarial samples x_{adv} have been generated in Step S203 for all the data (xₛⁱ, G^{j}) included in the data set X, the detection model learning device 200 terminates the loop L21.

When the detection model learning device 200 has terminated the loop L21 in Step S204, the training data set generator 211 generates the training data set Xₜᵣ using the guide image xₛⁱ included in the data set x and the adversarial sample x_{adv} generated for each data (xₛⁱ, G^{j}) included in the data set X (Step S205).

Next, the detection model learning device 200 starts loop L22 (Step S206).

In the process of Step S206, the detection model learner 212 selects B elements from the training data set Xₜᵣ to generate a mini-batch (Step S207).

Next, the detection model learner 212 learns the detection model d using the generated mini-batch.

Next, the detection model learning device 200 terminates the loop L22 (Step S209). Specifically, the detection model learning device 200 determines whether or not the process of the loop L22 has been repeated M₄ times. If it is determined that the process of loop L22 has not been repeated M₄ times, the detection model learning device 200 continues to repeat the process of loop L22.

On the other hand, if it is determined that the process of loop L22 has been repeated M₄ times, the detection model learning device 200 terminates loop L22.

When the loop L22 ends in Step S209, the detection model learning device 200 ends the processing of FIG. 8.

As described above, the detection model learner 212 uses the adversarial samples generated by the adversarial sample generator 111 to learn a detection model for detecting adversarial samples.

Thereby, the detection model learner 212 can learn a detection model using the adversarial sample x_{adv} having a feature quantity similar to the feature quantity of each of the plurality of guide images x_{g}^{j}. In this regard, the detection model obtained by the detection model learning device 200 is expected to be able to detect with high accuracy adversarial samples with a high risk of mis-collation, such as an adversarial sample x_{adv} with a high feature quantity similarity to various captured images taken during matching.

### Fifth Example Embodiment

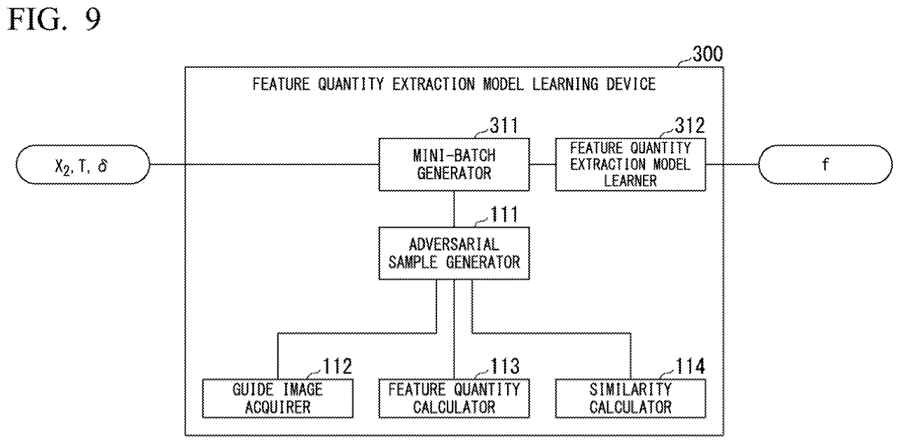

FIG. 9 is a schematic block diagram showing an example of the functional configuration of the feature quantity extraction model learning device according to the fifth example embodiment. With the configuration shown in FIG. 9, the feature quantity extraction model learning device 300 is provided with the adversarial sample generator 111, the guide image acquirer 112, the feature quantity calculator 113, the similarity calculator 114, a mini-batch generator 311, and a feature quantity extraction model learner 312.

In the configuration of FIG. 9, those portions having similar functions corresponding to the respective portions of FIG. 1 are given the same reference numerals (111, 112, 113, 114), and detailed description thereof will be omitted here.

The feature quantity extraction model learning device 300 is further provided with the mini-batch generator 311 and the feature quantity extraction model learner 312 in addition to the units included in the adversarial sample generation device 110 of FIG. 1.

The feature quantity extraction model learning device 300 uses the adversarial sample x_{adv} generated by the adversarial sample generator 111 as training data to perform learning of a feature quantity extraction model f that extracts the feature quantities of input data such as face images for face collation.

In the fifth example embodiment, the case of learning the feature quantity extraction model f using the adversarial sample x_{adv} obtained in the first example embodiment will be described.

However, instead of the first example embodiment, the adversarial sample x_{adv} obtained in the second example embodiment may be used to learn the feature quantity extraction model f. Alternatively, the feature quantity extraction model f may be learned using the adversarial sample x_{adv} obtained in the third example embodiment, which corresponds to a combination of the first example embodiment and the second example embodiment.

When learning the feature quantity extraction model f using the adversarial sample x_{adv} obtained in the second example embodiment, the feature quantity extraction model learning device 300 may be provided with the adversarial sample generator 121 and the constraint term calculator 122 of FIG. 3 in place of the adversarial sample generator 111 and the guide image acquirer 112 shown in FIG. 1.

When learning the feature quantity extraction model f using the adversarial sample x_{adv} obtained in the third example embodiment, the feature quantity extraction model learning device 300 may be further provided with the constraint term calculator 122 in addition to each unit shown in FIG. 9.

Moreover, the fourth example embodiment and the fifth example embodiment may be implemented together. In this case, the feature quantity extraction model learning device 300 may be further provided with the training data set generator 211 and the detection model learner 212 shown in FIG. 7.

The feature quantity extraction model learning device 300 acquires the data set X₂, the image transformation function set T, and the maximum perturbation size δ as input data, and outputs the feature quantity extraction model f. For example, the feature quantity extraction model learning device 300 may output the parameter values of the feature quantity extraction model f obtained by learning the feature quantity extraction model f.

The feature quantity extraction model learning device 300 corresponds to an example of an information processing device.

The data set X₂ is a set whose elements are a combination of the source image xₛⁱ, the class label y of the source image xₛⁱ, and the guide image set G^{j} (xₛⁱ, y, G^{j}).

The class label y is a label indicating the correct class into which the source image xₛⁱ is classified. That is, class label y indicates class i. For example, when a person whose face image is pre-registered as the source image xₛⁱ and a class are associated one-to-one, the class label y indicates identification information for identifying the person whose face is shown in the source image xₛⁱ. The class label y may be denoted as a one-hot vector or an integer, for example.

As described above, the image transformation function set T is a set of one or more image processing functions t.

The mini-batch generator 311 generates a mini-batch for learning the feature quantity extraction model f. The feature quantity extraction model learner 312 repeatedly updates the feature quantity extraction model f, and each time the feature quantity extraction model f is updated, the mini-batch generator 311 may generate a mini-batch and output the mini-batch to the feature quantity extraction model learner 312.

The mini-batch generator 311 generates a mini-batch having C elements, with each element being a pair of an image and a label. C is an integer, with C≥2. The value of C may be preset to a fixed value. Alternatively, the user may specify the value of C.

Specifically, the mini-batch generator 311 selects C elements from the data set X₂, and obtains the pair (xₛⁱ, y) of the source image xₛⁱ and the class label y for each selected element. Then, the mini-batch generator 311 selects D out of the obtained C pairs, and outputs the source images xₛⁱ of the selected D pairs to the adversarial sample generator 111. D is an integer satisfying 1≤D<C. The value of D may be preset to a fixed value. Alternatively, the user may specify the value of D.

The adversarial sample generator 111 generates an adversarial sample x_{adv} for each of the C source images xₛⁱ from the mini-batch generator 311 and outputs them to the mini-batch generator 311.

The latest feature quantity extraction model f updated by the feature quantity extraction model learner 312 may be used as the feature quantity extraction model f for the adversarial sample generator 111 to generate the adversarial sample x_{adv}.

The guide image set G^{j} may be output from the mini-batch generator 311 to the adversarial sample generator 111 together with the source images xₛⁱ. For each source image xₛⁱ, the mini-batch generator 311 may output to the adversarial sample generator 111 the guide image set G that is combined with that source image xₛⁱ in the data set X₂.

Regarding the image transformation function set T and the maximum perturbation size δ, the adversarial sample generator 111 may use the image transformation function set T and the maximum perturbation size δ included in the input data to the feature quantity extraction model learning device 300. In this case, the mini-batch generator 311 may output the image transformation function set T and the maximum perturbation size δ included in the input data to the feature quantity extraction model learning device 300 to the adversarial sample generator 111.

The mini-batch generator 311 replaces the source image xₛⁱ with the adversarial sample x_{adv} for the D pairs for which the adversarial sample generator 111 has generated an adversarial sample x_{adv}, among the C pairs (xₛⁱ, y).

After replacing the source image xₛⁱ with the adversarial sample x_{adv} for the D pairs, the mini-batch generator 311 outputs the C pairs to the feature quantity extraction model learner 312 as a mini-batch of learning data. Each element of this mini-batch is associated with either the source image xₛⁱ or the adversarial sample x_{adv}, and the class label y indicating the correct class.

The feature quantity extraction model learner 312 learns the feature quantity extraction model fusing the mini-batch generated by the mini-batch generator 311. For example, the feature quantity extraction model learner 312 learns the feature quantity extraction model f by solving an optimization problem using a loss function that indicates the evaluation of the feature quantity extraction model f to be learned.

As the loss function in this case, for example, when classifying the source image xₛⁱ or the adversarial sample x_{adv} using the feature quantity extraction model f to be learned, it is possible to use a loss function that evaluates the classification result according to whether the classification is correct or not.

The feature quantity extraction model learner 312 calculates a loss function using the mini-batch, applies a gradient method to solve an optimization problem that minimizes the loss indicated by the value of the loss function, and updates the parameters of the feature quantity extraction model f.

The feature quantity extraction model learner 312 repeats the updating of the parameters of the feature quantity extraction model f M₅ times. M₅ is an integer satisfying M₅≥1. The value of M₅ may be preset to a fixed value. Alternatively, the user may specify the value of M₅.

However, the loss function for learning the feature quantity extraction model f, the architecture of the feature quantity extraction model, the learning algorithm, and the meta-parameters such as the learning rate are not limited to specific ones, and various ones can be used.

### (Description of Operation)

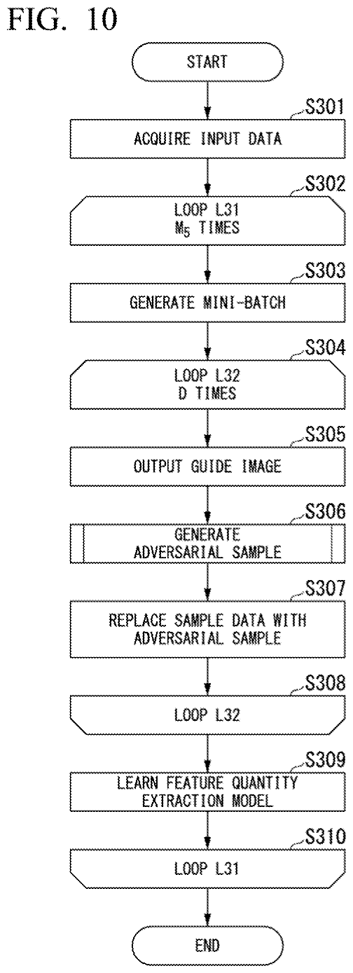

FIG. 10 is a flowchart showing an example of a processing procedure for the feature quantity extraction model learning device 300 to learn the feature quantity extraction model f.

In the process of FIG. 10, the mini-batch generator 311 acquires the data set X₂, the image transformation function set T, and the maximum perturbation size δ as input data from the outside of the feature quantity extraction model learning device 300 (Step S301).

Next, the feature quantity extraction model learning device 300 starts loop L31 (Step S302).

In the processing of loop L31, the mini-batch generator 311 generates a mini-batch having C elements (Step S303). Specifically, the mini-batch generator 311 selects C elements from the data set X₂, acquires the source image xₛⁱ and the class label y from each of the selected elements, and uses the pair (xₛⁱ, y) as elements of a mini-batch.

Next, the feature quantity extraction model learning device 300 starts loop L32 (Step S304).

In the process of loop L32, the mini-batch generator 311 outputs the one source image xₛⁱ included in the mini-batch to the adversarial sample generator 111 (Step S305).

Next, the feature quantity extraction model learning device 300 generates an adversarial sample x_{adv} using the source image xₛⁱ from the mini-batch generator 311 (Step S206). The feature quantity extraction model learning device 300 uses the source image xₛⁱ selected in Step S305, the guide image set G^{j} combined with the source image xₛⁱ in the data set X₂, the image transformation function set T included in the input data, and the maximum and perturbation size δ to generate the adversarial sample x_{adv}.

In Step S306, the feature quantity extraction model learning device 300 performs the processing of Step S102 and subsequent steps in FIG. 2 to generate the adversarial sample x_{adv}.

Next, the mini-batch generator 311 replaces the source image xₛⁱ selected in Step S305 among the source images xₛⁱ included in the mini-batch with the adversarial sample x_{adv} obtained in Step S306 (Step S307).

Next, the feature quantity extraction model learning device 300 performs termination processing of the loop L32 (Step S308). Specifically, the feature quantity extraction model learning device 300 determines whether or not the process of the loop L32 has been repeated D times. Upon determining that the process of loop L32 has not been repeated D times, the feature quantity extraction model learning device 300 continues to repeat the process of loop L32.

On the other hand, upon determining that the processing of loop L32 has been repeated D times, the feature quantity extraction model learning device 300 terminates loop L32.

When the feature quantity extraction model learning device 300 ends the loop L32 in Step S308, the feature quantity extraction model learner 312 learns the feature quantity extraction model f (Step S309). The feature quantity extraction model learner 312 learns the feature quantity extraction model f using the mini-batch after replacing the D source images xₛⁱ with the adversarial samples x_{adv}, and updates the parameters of the feature quantity extraction model f.

Next, the feature quantity extraction model learning device 300 performs termination processing of the loop L31 (Step S310). Specifically, the feature quantity extraction model learning device 300 determines whether or not the process of the loop L31 has been repeated M₅ times. Upon determining that the process of loop L31 has not been repeated M₅ times, the feature quantity extraction model learning device 300 continues to repeat the process of loop L31.

On the other hand, upon determining that the process of loop L31 has been repeated M₅ times, the feature quantity extraction model learning device 300 terminates loop L31.

When the loop L31 is ended in Step S310, the feature quantity extraction model learning device 300 ends the processing of FIG. 10.

As described above, the feature quantity extraction model learner 312 uses the adversarial sample x_{adv} generated by the adversarial sample generator 111 to learn the feature quantity extraction model f.

Thereby, the feature quantity extraction model learner 312 can learn the feature quantity extraction model f using the adversarial sample x_{adv} having a feature quantity similar to the feature quantity of each of the plurality of guide images x_{g}^{j}. In this regard, the detection model obtained by the feature quantity extraction model learning device 300 is expected to be able to perform face collation with high accuracy, even for face images with a high risk of mis-collation, such as an adversarial sample x_{adv} with a high feature quantity similarity to various captured images taken during matching.

### Sixth Example Embodiment

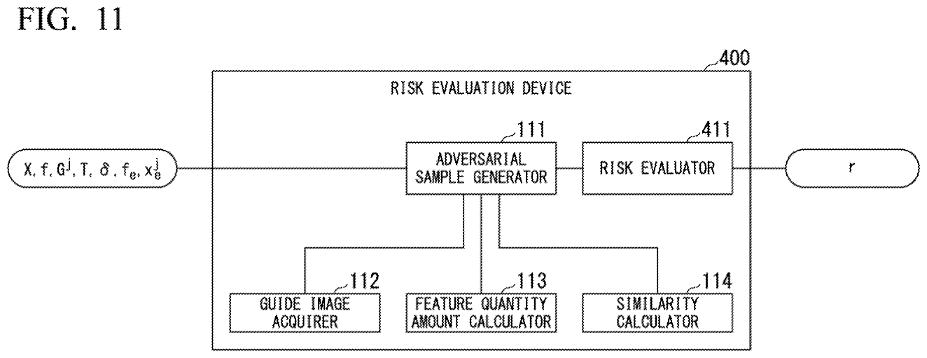

FIG. 11 is a schematic block diagram showing an example of the functional configuration of the risk evaluation device according to the sixth example embodiment. With the configuration shown in FIG. 11, a risk evaluation device 400 is provided with an adversarial sample generator 111, a guide image acquirer 112, a feature quantity calculator 113, a similarity calculator 114, and a risk evaluator 411.

In the configuration of FIG. 11, those portions having similar functions corresponding to the respective portions of FIG. 1 are given the same reference numerals (111, 112, 113, 114), and so detailed descriptions thereof will be omitted here.

The risk evaluation device 400 is further provided with the risk evaluator 411 in addition to the units included in the adversarial sample generation device 110 of FIG. 1.

The risk evaluation device 400 calculates the similarity between the feature quantity of the adversarial sample x_{adv} generated by the adversarial sample generator 111 and the feature quantity of the evaluation-use captured image x_{g}^{j} when using the evaluation feature quantity extraction model fₑ. The evaluation feature quantity extraction model fₑ and the evaluation-use captured image x_{g}^{j} are input to the risk evaluation device 400 from the outside of the risk evaluation device 400.

This similarity can be used as an evaluation index of the risk of mis-collation induced by the adversarial sample x_{adv}. Evaluation is possible such that the higher the degree of similarity, the higher the risk of mis-collation being induced.

Alternatively, this similarity can be used as an evaluation index of the risk of mis-collation being induced for the evaluation feature quantity extraction model fₑ. Evaluation is possible such that the higher the degree of similarity, the higher the risk of mis-collation being induced.

In the sixth example embodiment, the case of performing risk evaluation using the adversarial sample x_{adv} obtained in the first example embodiment will be described.

However, instead of the first example embodiment, the adversarial sample x_{adv} obtained in the second example embodiment may be used for risk evaluation. Alternatively, risk evaluation may be performed using the adversarial sample x_{adv} obtained in the third example embodiment, which corresponds to the combination of the first example embodiment and the second example embodiment.

When performing risk assessment using the adversarial sample x_{adv} obtained in the second example embodiment, the risk evaluation device 400 may be provided with the target sample generator 121 and the constraint term calculator 122 of FIG. 3 instead of the adversarial sample generator 111 and the guide image acquirer 112 in FIG. 1.

When risk evaluation is performed using the adversarial sample x_{adv} obtained in the third example embodiment, the risk evaluation device 400 may further include the constraint term calculator 122 in addition to the units shown in FIG. 11.

Furthermore, one or both of the fourth example embodiment and the fifth example embodiment may be combined with the sixth example embodiment.

When implementing the fourth example embodiment and the sixth example embodiment together, the risk evaluation device 400 may further be provided with the training data set generator 211 and the detection model learner 212 shown in FIG. 7.

When implementing the fifth example embodiment and the sixth example embodiment together, the risk evaluation device 400 may further be provided with the mini-batch generator 311 and the feature quantity extraction model learner 312 shown in FIG. 9.

The risk evaluation device 400 acquires the source image xₛⁱ, the feature quantity extraction model f, the guide image set Q the image transformation function set T, the maximum perturbation size δ, the evaluation feature quantity extraction model fₑ, and the evaluation-use captured image set Xₑ^{j} as input data, and outputs the degree of similarity between the feature quantity of the adversarial sample x_{adv} and the feature quantity of the evaluation-use captured image x_{g}^{j} included in the evaluation-use captured image set Xₑ^{j}.

The risk evaluation device 400 corresponds to an example of an information processing device.

As described above, the source image xₛⁱ is the face image from which the adversarial sample x_{adv} is generated. The adversarial sample x_{adv} is generated by adding adversarial perturbation to the source image xₛⁱ. The class to which the source image xₛⁱ belongs is denoted as class i.

As described above, the feature quantity extraction model f receives a face image as an input and outputs the feature quantity of the input face image. The feature quantity output by the feature quantity extraction model f is represented by a vector having real numbers as elements.

As described above, the guide image set G^{j} is a set of one or more guide images x_{g}^{j}. A guide image x_{g}^{j}∈G^{j} is a face image belonging to the target class. The target class is denoted as class j. The “j” in “G” indicates class j. The “j” in “x_{g}^{j}” also indicates class j.

As described above, the image conversion function set T is a set of one or more image conversion functions t. The image conversion function t∈T is a function that receives an image as an input and outputs a converted image. The elements of the image conversion function set T may include an identity conversion function that outputs an input image as it is.

As stated above, the maximum perturbation size δ is the maximum size of perturbations (adversarial perturbations) used during adversarial sample generation.

The evaluation feature quantity extraction model fₑ is a feature quantity extraction model used for evaluation. Similar to the feature quantity extraction model f, the evaluation feature quantity extraction model fₑ receives a face image as an input and outputs the feature quantity of the input face image. The feature quantity output by the evaluation feature quantity extraction model fₑ is represented by a vector having real numbers as elements.

An evaluation-use captured image set Xₑ^{j} is a set of one or more evaluation-use captured images xₑ^{j}. The evaluation-use captured image xₑ^{j}. is a face image data set for evaluation.

The evaluation-use captured image xₑ^{j} typically belongs to class j, which is the target class. The “j” in “xₑ^{j}” indicates the target class.

However, the evaluation-use captured image may belong to a class other than the target class. Here, the adversarial sample x_{adv} typically induces misclassification into the target class, but may also induce misclassification into classes other than the target class. By including evaluation-use captured images belonging to classes other than the target class in the evaluation-use captured image set, the risk evaluation device 400 can evaluate the risk of misclassification into classes other than the target class.

An evaluation-use captured image is denoted as “xₑ*”, including cases where it belongs to a class other than the target class. An evaluation-use captured image set is denoted as “Xₑ*”, including cases where it includes an evaluation-use captured image belonging to a class other than the target class.

The risk evaluator 411 calculates the similarity r between the feature quantity of the adversarial sample x_{adv} generated by the adversarial sample generator 111 and the feature quantity of the evaluation-use captured image xₑ* using the evaluation feature quantity extraction model fₑ.

The risk evaluator 411 calculates the degree of similarity r, for example, based on Equation (10).

[Equation 10]

r=SIM (fₑ(x_{adv}),fₑ(Xₑ*)) (10)

As described above, as the similarity calculation function SIM, a function such as the cosine similarity cos(fₑ(x_{adv}), fₑ(xₑ*)) can be used to indicate that the higher the numerical value, the higher the similarity between the two feature quantities.

When the evaluation-use captured image set Xₑ* includes a plurality of evaluation-use captured images xₑ*, the risk evaluator 411 may calculate the similarity r for each evaluation-use captured image xₑ* included in the evaluation-use captured image set Xₑ*.

### (Description of Operation)

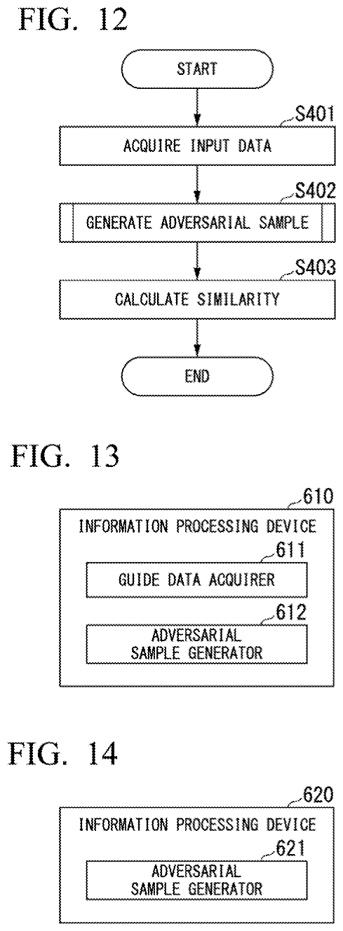

FIG. 12 is a flowchart showing an example of a processing procedure of the risk evaluation device 400 calculating the degree of similarity r.

In the process of FIG. 12, the adversarial sample generator 111 acquires the source image xₛⁱ, the feature quantity extraction model f, the guide image set G^{j}, the image transformation function set T, the maximum perturbation size δ, the evaluation feature quantity extraction model fₑ, and the evaluation-use captured image set Xₑ^{j} as input data from the outside of the risk evaluation device 400 (Step S401).

Next, the risk evaluation device 400 generates an adversarial sample x_{adv} (Step S402). The risk evaluation device 400 uses the source image xₛ¹, the feature quantity extraction model f, the guide image set G^{j}, the image transformation function set T, and the maximum perturbation size δ included in the input data to generate the adversarial sample x_{adv}.

At Step S402, the risk evaluation device 400 performs the processing from Step S102 onward in FIG. 2 to generate the adversarial sample x_{adv}.

When the evaluation-use captured image set Xₑ* includes a plurality of evaluation-use captured images xₑ*, the risk evaluation device 400 generates the adversarial sample x_{adv} for each evaluation-use captured image xₑ* included in the evaluation-use captured image set Xₑ*.

Next, the risk evaluator 411 calculates the similarity r using the adversarial sample x_{adv} obtained in Step S402, the evaluation feature quantity extraction model fₑ, and the evaluation-use captured image xₑ* (Step S403).

When the risk evaluation device 400 generates a plurality of adversarial samples x_{adv} in Step S402, the risk evaluator 411 calculates the similarity r for each of the adversarial samples x_{adv}.

After Step S403, the risk evaluation device 400 terminates the processing of FIG. 12.

As described above, the risk evaluator 411 calculates the similarity r between the feature quantity of the adversarial sample x_{adv} generated by the adversarial sample generator 111 and the feature quantity of the face image of the target class as an evaluation value of misrecognition by the adversarial sample x_{adv}.

Thereby, the risk evaluation device 400 can present an evaluation value of the risk of misrecognition by the adversarial sample x_{adv} to the user.

Alternatively, the degree of similarity r may be used as an evaluation value of the risk of misrecognition when using the evaluation feature quantity extraction model fₑ. In this case, the risk evaluation device 400 can present to the user an evaluation value of the risk of misrecognition when using the evaluation feature quantity extraction model fₑ.

### Seventh Example Embodiment

FIG. 13 is a block diagram showing an example of the configuration of the information processing device according to the seventh example embodiment. With the configuration shown in FIG. 13, an information processing device 610 is provided with a guide data acquirer 611 and an adversarial sample generator 612.

With such a configuration, the guide data acquirer 611 acquires a plurality of guide data items classified into a single target class. The adversarial sample generator 612 uses the multiple items of guide data to generate one adversarial sample.

Thereby, the adversarial sample generator 612 can generate an adversarial sample having a feature quantity similar to each of the feature quantities of the plurality of guide images. In this respect, the adversarial sample generator 612 can generate adversarial samples with high feature quantity similarity to the various data obtained from the class classification target.

In this way, according to the information processing device 610, an adversarial sample is obtained that can be determined to be similar to a plurality of data items of the target class by the determination of a model obtained by machine learning.

For example, by using this adversarial sample as training data, it is possible to take measures such as learning a model that is less likely to be deceived by this adversarial sample.

### Eighth Example Embodiment

FIG. 14 is a block diagram showing an example of the configuration of the information processing device according to the eighth example embodiment. With the configuration shown in FIG. 14, an information processing device 620 is provided with an adversarial sample generator 621.

With such a configuration, the adversarial sample generator 621 generates an adversarial sample using an objective function containing a term indicating the similarity between a feature quantity of an adversarial sample candidate and feature quantities of guide data items classified into a target class, and a term indicating the norm between the feature quantity of the adversarial sample candidate and the feature quantities of the guide data items.

The adversarial sample generator 621 can generate an adversarial sample having a feature quantity similar to the feature quantity of not only one specific guide image but also each of a plurality of guide images, using the term indicating the norm. In this respect, the adversarial sample generator 621 can generate adversarial samples with high feature quantity similarity to the various data obtained from the class classification target.

In this way, according to the information processing device 620, an adversarial sample is obtained that can be determined to be similar to a plurality of data items of the target class by the determination of a model obtained by machine learning.

For example, by using this adversarial sample as training data, it is possible to take measures such as learning a model that is less likely to be deceived by this adversarial sample.

### Ninth Example Embodiment

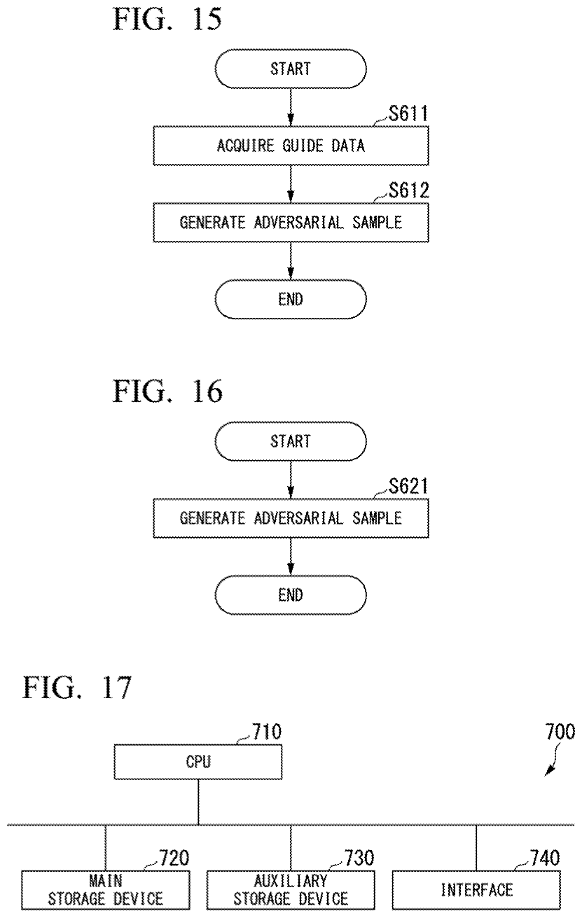

FIG. 15 is a diagram showing an example of the processing procedure in an information processing method according to the ninth example embodiment. The information processing method shown in FIG. 15 includes a step of acquiring guide data (Step S611) and a step of generating an adversarial sample (Step S612).

In the step of acquiring guide data (Step S611), a plurality of guide data items classified into a single target class are acquired. In the step of generating an adversarial sample (Step S612), one adversarial sample is generated using a plurality of guide data items.

According to the information processing method shown in FIG. 15, it is possible to generate an adversarial sample having a feature quantity similar to the feature quantity of each of the plurality of guide data items. According to the information processing method shown in FIG. 15, in this respect, it is possible to generate an adversarial sample with a high feature quantity similarity to the various data obtained from the class classification target.

In this way, according to the information processing method shown in FIG. 15, an adversarial sample is obtained that can be determined to be similar to a plurality of data items of the target class by the determination of a model obtained by machine learning.

For example, by using this adversarial sample as training data, it is possible to take measures such as learning a model that is less likely to be deceived by this adversarial sample.

### Tenth Example Embodiment

FIG. 16 is a diagram showing an example of the processing procedure in the information processing method according to the tenth example embodiment. The information processing method shown in FIG. 16 includes a step of generating an adversarial sample (Step S621).

The step of generating an adversarial sample (Step S621) generates an adversarial sample using an objective function containing a term indicating the similarity between a feature quantity of an adversarial sample candidate and feature quantities of guide data items classified into the target class, and a term indicating the norm between the feature quantity of the adversarial sample candidate and the feature quantities of the guide data items.

According to the information processing method shown in FIG. 16, it is possible to generate an adversarial sample having a feature quantity similar to not only the feature quantity of one particular guide data but also each of the plurality of guide data items. According to the information processing method shown in FIG. 16, in this respect, it is possible to generate an adversarial sample with a high feature quantity similarity to the various data obtained from the class classification target.

In this way, according to the information processing method shown in FIG. 16, an adversarial sample is obtained that can be determined to be similar to a plurality of data items of the target class by the determination of a model obtained by machine learning.

For example, by using this adversarial sample as training data, it is possible to take measures such as learning a model that is less likely to be deceived by this adversarial sample.

FIG. 17 is a schematic block diagram showing the configuration of a computer according to at least one example embodiment.

With the configuration shown in FIG. 17, a computer 700 includes a CPU 710, a main storage device 720, an auxiliary storage device 730, and an interface 740.

Any one of the adversarial sample generation device 110, the adversarial sample generation device 120, the adversarial sample generation device 130, the detection model learning device 200, the feature quantity extraction model learning device 300, the risk evaluation device 400, the information processing device 610, and the information processing device 620 may be implemented in the computer 700. In that case, the operation of each processor unit described above is stored in the auxiliary storage device 730 in the form of a program. The CPU 710 reads out the program from the auxiliary storage device 730, deploys the program in the main storage device 720, and executes the above processing according to the program. In addition, the CPU 710 reserves a storage area used for processing in the main storage device 720 according to the program. Communication between each device and another device is performed by the interface 740 having a communication function and performing communication under the control of the CPU 710.

When the adversarial sample generation device 110 is implemented in the computer 700, the operations of the adversarial sample generator 111, the guide image acquirer 112, the feature quantity calculator 113, and the similarity calculator 114 are stored in the auxiliary storage device 730 in the form of a program. The CPU 710 reads out the program from the auxiliary storage device 730, deploys the program in the main storage device 720, and executes the above processing according to the program.

In addition, the CPU 710 secures a storage area for use by the adversarial sample generation device 110 in the main storage device 720 according to the program.

Communication performed by the adversarial sample generation device 110 is performed by the interface 740 having a communication device and performing communication under the control of the CPU 710. The image display performed by the adversarial sample generation device 110 is performed by the interface 740 having a display device and displaying the image under the control of the CPU 710. Acceptance of user operations to the adversarial sample generation device 110 is performed by the interface 740 having an input device and accepting user operations.

When the adversarial sample generation device 120 is implemented in the computer 700, the operations of the adversarial sample generator 121, the feature quantity calculator 113, the constraint term calculator 122, and the similarity calculator 114 are stored in the auxiliary storage device 730 in the form of a program. The CPU 710 reads out the program from the auxiliary storage device 730, deploys the program in the main storage device 720, and executes the above processing according to the program.

In addition, the CPU 710 secures a storage area for use by the adversarial sample generation device 120 in the main storage device 720 according to the program.

Communication performed by the adversarial sample generation device 120 is performed by the interface 740 having a communication device and performing communication under the control of the CPU 710. The image display performed by the adversarial sample generation device 120 is performed by the interface 740 having a display device and displaying the image under the control of the CPU 710. Acceptance of user operations to the adversarial sample generation device 120 is performed by the interface 740 having an input device and accepting user operations.

When the adversarial sample generation device 130 is implemented in the computer 700, the operations of the adversarial sample generator 131, the guide image acquirer 112, the feature quantity calculator 113, the constraint term calculator 122, and the similarity calculator 114 are stored in the auxiliary storage device 730 in the form of a program. The CPU 710 reads out the program from the auxiliary storage device 730, deploys the program in the main storage device 720, and executes the above processing according to the program.

In addition, the CPU 710 secures a storage area for use by the adversarial sample generation device 130 in the main storage device 720 according to the program.

Communication performed by the adversarial sample generation device 130 is performed by the interface 740 having a communication device and performing communication under the control of the CPU 710. The image display performed by the adversarial sample generation device 130 is performed by the interface 740 having a display device and displaying the image under the control of the CPU 710. Acceptance of user operations to the adversarial sample generation device 130 is performed by the interface 740 having an input device and accepting user operations.

When detection model learning device 200 is implemented in the computer 700, the operations of the adversarial sample generator 111, the guide image acquirer 112, the feature quantity calculator 113, the similarity calculator 114, the training data set generator 211, and the detection model learner 212 are stored in auxiliary storage device 730 in the form of a program. The CPU 710 reads out the program from the auxiliary storage device 730, deploys the program in the main storage device 720, and executes the above processing according to the program.

In addition, the CPU 710 secures a storage area for use by the detection model learning device 200 in the main storage device 720 according to the program.

Communication performed by the detection model learning device 200 is performed by the interface 740 having a communication device and performing communication under the control of the CPU 710. The image display performed by the detection model learning device 200 is executed by the interface 740 having a display device and displaying the image under the control of the CPU 710. A user operation is accepted by the detection model learning device 200 by having the interface 740 equipped with an input device and accepting a user operation.

When the feature quantity extraction model learning device 300 is implemented in the computer 700, the operations of the adversarial sample generator 111, the guide image acquirer 112, the feature quantity calculator 113, the similarity calculator 114, the mini-batch generator 311, and the feature quantity extraction model learner 312 are stored in the auxiliary storage device 730 in the form of a program. The CPU 710 reads out the program from the auxiliary storage device 730, deploys the program in the main storage device 720, and executes the above processing according to the program.

Also, the CPU 710 secures a storage area in the main storage device 720 to be used by the feature quantity extraction model learning device 300 according to the program.

Communication performed by the feature quantity extraction model learning device 300 is performed by the interface 740 having a communication device and performing communication under the control of the CPU 710. The image display performed by the feature quantity extraction model learning apparatus 300 is executed by the interface 740 having a display device and displaying the image under the control of the CPU 710. A user operation is accepted by the feature quantity extraction model learning device 300 by having the interface 740 equipped with an input device and accepting a user operation.

When the risk evaluation device 400 is implemented in the computer 700, the operations of the adversarial sample generator 111, the guide image acquirer 112, the feature quantity calculator 113, the similarity calculator 114, and the risk evaluator 411 are stored in the auxiliary storage device 730 in the form of a program. The CPU 710 reads out the program from the auxiliary storage device 730, deploys the program in the main storage device 720, and executes the above processing according to the program.

In addition, the CPU 710 secures a storage area for use by risk evaluation device 400 in main storage device 720 according to the program.

Communication performed by the risk evaluation device 400 is performed by the interface 740 having a communication device and performing communication under the control of the CPU 710. The image display performed by the risk evaluation device 400 is performed by the interface 740 having a display device and displaying the image under the control of the CPU 710. A user operation is accepted by the risk evaluation device 400 by having the interface 740 equipped with an input device and accepting a user operation.

When the information processing device 610 is implemented in the computer 700, the operations of the guide data acquirer 611 and the adversarial sample generator 612 are stored in the auxiliary storage device 730 in the form of a program. The CPU 710 reads out the program from the auxiliary storage device 730, deploys the program in the main storage device 720, and executes the above processing according to the program.

In addition, the CPU 710 secures a storage area for use by information processing device 610 in main storage device 720 according to the program.

Communication performed by the information processing device 610 is performed by the interface 740 having a communication device and performing communication under the control of the CPU 710. The image display performed by the information processing device 610 is performed by the interface 740 having a display device and displaying the image under the control of the CPU 710. A user operation is accepted by the information processing device 610 by having the interface 740 equipped with an input device and accepting a user operation.

When the information processing device 620 is implemented in the computer 700, the operation of the adversarial sample generator 621 is stored in the auxiliary storage device 730 in the form of a program. The CPU 710 reads out the program from the auxiliary storage device 730, deploys the program in the main storage device 720, and executes the above processing according to the program.

In addition, the CPU 710 secures a storage area for use by information processing device 620 in main storage device 720 according to the program.

Communication performed by the information processing device 620 is performed by the interface 740 having a communication device and performing communication under the control of the CPU 710. The image display performed by the information processing device 620 is performed by the interface 740 having a display device and displaying the image under the control of the CPU 710. A user operation is accepted by the information processing device 620 by having the interface 740 equipped with an input device and accepting a user operation.

In addition, all or some of the processes performed by the adversarial sample generation device 110, the adversarial sample generation device 120, the adversarial sample generation device 130, the detection model learning device 200, the feature quantity extraction model learning device 300, the risk evaluation device 400, the information processing device 610, and the information processing device 620 may be recorded on a computer-readable recording medium, and the program recorded on this recording medium may be read into a computer system and executed, whereby the processing of each unit may be performed. It should be noted that the “computer system” referred to here includes an operating system and hardware such as peripheral devices.

In addition, the “computer-readable recording medium” refers to portable media such as flexible discs, magneto-optical discs, ROMs (Read Only Memories), CD-ROMs (Compact Disc Read Only Memories), and storage devices such as hard disks built into computer systems. Further, the program may be for realizing some of the functions described above, or may be capable of realizing the functions described above in combination with a program already recorded in the computer system.

Although example embodiments of the present invention have been described in detail with reference to the drawings, the specific configuration is not limited to these example embodiments, and designs and the like are included within the scope of the gist of the present invention.

Moreover, some or all of the above example embodiments can be described as in the supplementary notes below, but are not limited thereto.

### (Supplementary Note 1)

An information processing device including:
a guide data acquirer that acquires a plurality of guide data items classified into a single target class; and
an adversarial sample generator that generates one adversarial sample by using the plurality of guide data items.

### (Supplementary Note 2)

The information processing device according to Supplementary Note 1, wherein the guide data acquirer acquires a plurality of real data items classified into the target class as the plurality of guide data items.

### (Supplementary Note 3)

The information processing device according to Supplementary Note 1 or 2, wherein the guide data acquirer converts one or more of the guide data items to generate a new guide data item.

### (Supplementary Note 4)

The information processing device according to any one of Supplementary Notes 1 to 3, wherein the adversarial sample generator generates the adversarial sample using an objective function containing a term indicating the similarity between a feature quantity of an adversarial sample candidate and feature quantities of the guide data items, and a term indicating the norm between the feature quantity of the adversarial sample candidate and the feature quantities of the guide data items.

### (Supplementary Note 5)

The information processing device according to any one of Supplementary Notes 1 to 4, further including:
a detection model learner that uses an adversarial sample generated by the adversarial sample generator to learn a detection model that detects adversarial samples.

### (Supplementary Note 6)

The information processing device according to any one of Supplementary Notes 1 to 5, further including:
a feature quantity extraction model learner that uses an adversarial sample generated by the adversarial sample generator to learn a feature quantity extraction model for data classification.

### (Supplementary Note 7)

The information processing device according to any one of Supplementary Notes 1 to 6, further including:
a risk evaluator that calculates the similarity between the feature quantity of an adversarial sample generated by the adversarial sample generator and the feature quantities of the target class data as an evaluation value of the risk of misidentification by the adversarial sample.

### (Supplementary Note 8)

An information processing device including:
an adversarial sample generator that generates an adversarial sample using an objective function containing a term indicating the similarity between a feature quantity of an adversarial sample candidate and feature quantities of guide data items classified into a target class, and a term indicating the norm between the feature quantity of the adversarial sample candidate and the feature quantities of the guide data items.

### (Supplementary Note 9)

The information processing device according to Supplementary Note 8, further including a guide data acquirer that acquires a plurality of guide data items classified into a single target class,
wherein the adversarial sample generator generates one adversarial sample by using the plurality of guide data items.

### (Supplementary Note 10)

The information processing device according to Supplementary Note 9, wherein the guide data acquirer acquires a plurality of real data items classified into the target class as the plurality of guide data items.

### (Supplementary Note 11)

The information processing device according to Supplementary Note 9 or Supplementary Note 10, wherein the guide data acquirer converts the real data items classified into the target class to generate the guide data items.

### (Supplementary Note 12)

The information processing device according to any one of Supplementary Notes 8 to 11, further including:
a detection model learner that uses an adversarial sample generated by the adversarial sample generator to learn a detection model that detects adversarial samples.

### (Supplementary Note 13)

The information processing device according to any one of Supplementary Notes 8 to 12, further including:
a feature quantity extraction model learner that uses an adversarial sample generated by the adversarial sample generator to learn a feature quantity extraction model for data classification.

### (Supplementary Note 14)

The information processing device according to any one of Supplementary Notes 8 to 15, further including:
a risk evaluator that calculates the similarity between the feature quantity of an adversarial sample generated by the adversarial sample generator and the feature quantities of the target class data as an evaluation value of the risk of misidentification by the adversarial sample.

### (Supplementary Note 15)

An information processing method including:
acquiring a plurality of guide data items classified into a single target class; and
generating one adversarial sample by using the plurality of guide data items.

### (Supplementary Note 16)

An information processing method including:
generating an adversarial sample using an objective function containing a term indicating the similarity between a feature quantity of an adversarial sample candidate and feature quantities of guide data items classified into a target class, and a term indicating the norm between the feature quantity of the adversarial sample candidate and the feature quantities of the guide data items.

### (Supplementary Note 17)

A recording medium that records a program for causing a computer to execute: acquiring a plurality of guide data items classified into a single target class; and generating one adversarial sample by using the plurality of guide data items.

### (Supplementary Note 18)

A recording medium that records a program for causing a computer to execute:
generating an adversarial sample using an objective function containing a term indicating the similarity between a feature quantity of an adversarial sample candidate and feature quantities of guide data items classified into a target class, and a term indicating the norm between the feature quantity of the adversarial sample candidate and the feature quantities of the guide data items.

### INDUSTRIAL APPLICABILITY

The example embodiments of the present invention may be applied to an information processing device, an information processing method, and a recording medium.

### REFERENCE SIGNS LIST

110, 120, 130 Adversarial sample generation device
111, 121, 131, 612, 621 Adversarial sample generator
112 Guide image acquirer
113 Feature quantity calculator
114 Similarity calculator
122 Constraint term calculator
200 Detection model learning device
211 Training data set generator
212 Detection model leamer
300 Feature quantity extraction model learning device
311 Mini-batch generator
312 Feature quantity extraction model learner
400 Risk evaluation device
411 Risk evaluator
610, 620 Information processing device
611 Guide data acquirer

What is claimed is:

1. An information processing device comprising:
a guide data acquirer that acquires a plurality of guide data items classified into a single target class; and
an adversarial sample generator that generates one adversarial sample by using the plurality of guide data items.

2. The information processing device according to claim 1,
wherein the guide data acquirer acquires a plurality of real data items classified into the target class as the plurality of guide data items.

3. The information processing device according to claim 1,
wherein the guide data acquirer converts one or more of the guide data items to generate a new guide data item.

4. The information processing device according to claim 1,
wherein the adversarial sample generator generates the adversarial sample using an objective function containing a term indicating the similarity between the feature quantity of an adversarial sample candidate and the feature quantities of the guide data items, and a term indicating the norm between the feature quantity of the adversarial sample candidate and the feature quantities of the guide data items.

5. The information processing device according to claim 1, the information processing device further comprising:
a detection model learner that uses an adversarial sample generated by the adversarial sample generator to learn a detection model that detects adversarial samples.

6. The information processing device according to claim 1, the information processing device further comprising:
a feature quantity extraction model learner that uses an adversarial sample generated by the adversarial sample generator to learn a feature quantity extraction model for data classification.

7. The information processing device according to claim 1, the information processing device further comprising:
a risk evaluator that calculates the similarity between the feature quantity of an adversarial sample generated by the adversarial sample generator and the feature quantities of the target class data as an evaluation value of the risk of misidentification by the adversarial sample.

8. An information processing device comprising:
an adversarial sample generator that generates an adversarial sample using an objective function containing a term indicating the similarity between a feature quantity of an adversarial sample candidate and feature quantities of guide data items classified into a target class, and a term indicating the norm between the feature quantity of the adversarial sample candidate and the feature quantities of the guide data items.

9. An information processing method comprising:
acquiring a plurality of guide data items classified into a single target class; and
generating one adversarial sample by using the plurality of guide data items.

10-12. (canceled)

13. The information processing device according to claim 8, the information processing device further comprising:
a guide data acquirer that acquires a plurality of guide data items classified into a single target class,
wherein the adversarial sample generator generates one adversarial sample by using the plurality of guide data items.

14. The information processing device according to claim 13,
wherein the guide data acquirer acquires a plurality of real data items classified into the target class as the plurality of guide data items.

15. The information processing device according to claim 13,
wherein the guide data acquirer converts the real data items classified into the target class to generate the guide data items.

16. The information processing device according to claim 8, the information processing device further comprising:
a detection model learner that uses an adversarial sample generated by the adversarial sample generator to learn a detection model that detects adversarial samples.

17. The information processing device according to claim 8, the information processing device further comprising:
a feature quantity extraction model learner that uses an adversarial sample generated by the adversarial sample generator to learn a feature quantity extraction model for data classification.

18. The information processing device according to claim 8, the information processing device further comprising:
a risk evaluator that calculates the similarity between the feature quantity of an adversarial sample generated by the adversarial sample generator and the feature quantities of the target class data as an evaluation value of the risk of misidentification by the adversarial sample.
